(19) United States
(12) Patent Application Publication
(10) Pub. No.: US 2026/0292439 A1
(43) Pub. Date: Sep. 24, 2026

(54) SYSTEMS AND METHODS OF GEOFENCE CREATION USING CLUSTERING AND GPS DATA POINT CLASSIFICATION

(71) Applicant: IntelliCulture Inc., Mississauga (CA)

(72) Inventors: Julie Lovitt, Ottawa (CA); Urban Pistek, Calgary (CA); Wenhao Wu, Calgary (CA)

(73) Assignee: IntelliCulture Inc., Mississauga (CA)

(21) Appl. No.: 19/083,963

(22) Filed: Mar. 19, 2025

(51) Int. Cl. H04W 4/021; G06V 10/762; G06V 20/13; H04W 4/029; H04W 4/40

(52) U.S. Cl. CPC H04W 4/021; G06V 10/762; G06V 20/13; H04W 4/029; H04W 4/40

(57) ABSTRACT

A system of geofence creation can include one or more processors to execute instructions stored in memory to obtain a plurality of global positioning system (GPS) data points from a device of each of one or more agricultural vehicles operating within a geographical region; cluster the plurality of GPS data points into a plurality of clusters; classify each GPS data point into one of a plurality of activity classes; merge a pair of clusters of the plurality of clusters into a merged cluster; determine the merged cluster is not within any geofences of the geographical region; and responsive to the determination, generate a geofence in an area surrounding the merged cluster within the geographical region.

### BACKGROUND

Agricultural farms can use farm equipment to facilitate growing various types of crops. For example, a farm can use a tractor or other gas-powered or electric vehicle to spray the crops or perform other tasks on the farm. However, as farms become larger or become consolidated with other farms, and farming tasks become more complicated or numerous, it can be challenging to accurately and efficiently track a vehicle's performance of a task on the farm.

### SUMMARY

Farm management software can require accurate and holistic coverage of a farm owner's geofences for data collection. Inaccuracies in the geometry and representation of a customer's work areas can cause errors in calculated metrics and lead to incorrect operational insights. A technical issue with relying on geofences for data collection and metric calculation can be the reliance on pre-configuration of accurate geofence geometry and location for generating metrics that are useable by users.

A data processing system can overcome the aforementioned technical issue by automatically generating geofences in areas in which individuals or vehicles work but for which there is not a predefined geofence. To do so, the data processing system can collect GPS and other data points through a data logger connected to farm equipment via automotive auxiliary power outlets or diagnostic connectors. Using density-based clustering techniques, the data processing system can classify the clustered GPS data points as work activity, drive activity, or clustered activity, then merge relevant clusters while filtering out those without work activity data points or those that intersect with existing geofences. The data processing system can contour the areas around the remaining clusters to generate cores, which can be filtered to avoid overlap with existing geofences. The cores can be processed with images depicting the area surrounding the cores through an image segmentation model to determine boundaries for the separate cores. The data processing system can generate new geofences along these boundaries to define previously unrecorded work areas. Subsequently, the data processing system can collect and generate metrics for work performed within the areas defined by the new geofences.

A technical problem that can arise when collecting and analyzing data generated by farm equipment is that doing so can require accurate row bearing values (e.g., values between 0 and 180 degrees) of crop rows in the field. Conventional systems may operate based on user inputs into a user interface in which a user draws line segments along crop rows present in basemap imagery depicted on the user interface. Such systems can retrieve the angles of the lines and use the angles to generate metrics based on field work performed in the crop rows. However, such processes can be time consuming and inaccurate because they rely on images of crop rows that may have varying resolutions. Any small variation in the accuracy of a row bearing of a crop row can cause metrics generated from work performed in the crop row to be inaccurate or events (e.g., mis-spraying or mis-seeding events) difficult to generate or detect.

The data processing system can overcome the aforementioned technical issue by automatically generating row bearings with a multi-pronged approach. For example, the data processing system can identify an image of a geographical region including an agricultural field outlined by a geofence and a plurality of global positioning system (GPS) data points indicating locations of agricultural vehicles operating within the agricultural field. The data processing system can sample a portion of the image depicting one or more rows (e.g., crop rows) of the agricultural field to generate one or more image samples. The data processing system can compare each image sample to a set of row bearing templates that each correspond to a different row bearing. The data processing system can identify the row bearing template with a highest similarity with the image sample and identify the row bearing corresponding to the row bearing template for the image sample. The data processing system can similarly determine row bearings that correspond to each image sample. The data processing system can determine a first candidate row bearing for the geofence based on or as a function of the row bearing determined for each image sample. Additionally, the data processing system can generate line segments from GPS data points corresponding to the locations of vehicles traveling within the agricultural field (e.g., traversing the rows the agricultural field). The data processing system can determine a second candidate row bearing based on the generated line segments.

The data processing system can use the two candidate row bearings to determine a row bearing for the geofence. The data processing system can assign the determined row bearing to the geofence and then use the assigned row bearing to generate work data or key performance indicators (KPIs) for work performed within the geofence. The data processing system can repeat this process for any number of geofences corresponding to locations depicted in the image or other images and using GPS data points generated within the geographic locations of the geofences. The dual-pronged approach of using an image and separately captured GPS data points can reduce the dependency on image quality or accurate location sensors to determine row bearings for rows and, thus, improve the reliability and accuracy of the row bearings for subsequent accurate work data generation.

At least one aspect of a technical solution is directed to a system of geofence creation. The system can include one or more processors to execute instructions stored in memory to obtain a plurality of global positioning system (GPS) data points from a device of each of one or more agricultural vehicles. Each GPS data point can indicate a location of an agricultural vehicle operating within a geographical region. One or more subsets of the plurality of GPS data points can each correspond to a different line segment having a start point GPS data point and an end point GPS data point. The one or more processors can cluster the plurality of GPS data points into a plurality of clusters according to a density-based clustering protocol. The one or more processors can classify, using a machine learning model, each GPS data point into one of a plurality of activity classes comprising drive activity, work activity, and clustered activity. The one or more processors can merge a pair of clusters of the plurality of clusters into a merged cluster based at least on a first cluster of the pair of clusters comprising a first start point GPS data point of a line segment and a second cluster of the pair of clusters comprising a first end point GPS data point of the line segment and the first cluster and the second cluster each comprising one or more GPS data points of a common activity classification. The one or more processors can determine the merged cluster is not within any geofences of the geographical region. The one or more processors can, responsive to the determination, generate a geofence in an area surrounding the merged cluster within the geographical region.

At least one aspect of a technical solution is directed to a method of geofence creation. The method can include obtaining, by one or more processors, a plurality of global positioning system (GPS) data points from a device of each of one or more agricultural vehicles. Each GPS data point can indicate a location of an agricultural vehicle operating within a geographical region. One or more subsets of the plurality of GPS data points can each corresponding to a different line segment having a start point GPS data point and an end point GPS data point. The method can include clustering, by the one or more processors, the plurality of GPS data points into a plurality of clusters according to a density-based clustering protocol. The method can include classifying, by the one or more processors using a machine learning model, each GPS data point into one of a plurality of activity classes comprising drive activity, work activity, and clustered activity. The method can include merging, by the one or more processors, a pair of clusters of the plurality of clusters into a merged cluster based at least on a first cluster of the pair of clusters comprising a first start point GPS data point of a line segment and a second cluster of the pair of clusters comprising a first end point GPS data point of the line segment and the first cluster and the second cluster each comprising one or more GPS data points of a common activity classification. The method can include determining, by the one or more processors, the merged cluster is not within any geofences of the geographical region. The method can include, responsive to the determining the merged cluster is not within any geofences of the geographical region, generating, by the one or more processors, a geofence in an area surrounding the merged cluster within the geographical region.

At least one aspect of a technical solution is directed to a system of agricultural row bearing identification. The system can include one or more processors configured by instructions stored in memory to identify an image of a geographical region including an agricultural field and a plurality of global positioning system (GPS) data points from a device of each of one or more agricultural vehicles. Each GPS data point can indicate a location of an agricultural vehicle operating within the geographical region. The one or more processors can be configured to sample a portion of the image of the geographical region depicting the agricultural field into a plurality of image samples. The one or more processors can be configured to, for each image sample, select a row bearing template from a plurality of row bearing templates corresponding to different row bearings based on a similarity between the row bearing template and the image sample, the row bearing template corresponding to a sample row bearing. The one or more processors can be configured to determine a first candidate row bearing for the portion of the image based on the sample row bearings. The one or more processors can be configured to identify one or more of the plurality of GPS data points that correspond to locations depicted in the portion of the image. The one or more processors can be configured to generate one or more line segments from the one or more GPS data points. The one or more processors can be configured to determine a second candidate row bearing based on the one or more line segments generated from the one or more GPS data points. The one or more processors can be configured to, responsive to determining the first candidate row bearing is within a threshold of the second candidate row bearing, determine a row bearing based on the first candidate row bearing or the second candidate row bearing. The one or more processors can be configured to store an association between the row bearing and the portion of the image in memory.

At least one aspect of a technical solution is directed to a method of agricultural row bearing identification. The method can include identifying, by one or more processors, an image of a geographical region including an agricultural field and a plurality of global positioning system (GPS) data points from a device of each of one or more agricultural vehicles. Each GPS data point can indicate a location of an agricultural vehicle operating within the geographical region. The method can include sampling, by the one or more processors, a portion of the image of the geographical region depicting the agricultural field into a plurality of image samples. The method can include, for each image sample, select a row bearing template from a plurality of row bearing templates corresponding to different row bearings based on a similarity between the row bearing template and the image sample, the row bearing template corresponding to a sample row bearing. The method can include determining, by the one or more processors, a first candidate row bearing for the portion of the image based on the sample row bearings. The method can include identifying, by the one or more processors, one or more of the plurality of GPS data points that correspond to locations depicted in the portion of the image. The method can include generating, by the one or more processors, one or more line segments from the one or more GPS data points. The method can include determining, by the one or more processors, a second candidate row bearing based on the one or more line segments generated from the one or more GPS data points. The method can include, responsive to determining the first candidate row bearing is within a threshold of the second candidate row bearing, determining, by the one or more processors, a row bearing based on the first candidate row bearing or the second candidate row bearing. The method can include storing, by the one or more processors, an association between the row bearing and the portion of the image in memory.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system of generating geofences and detecting row bearings, in accordance with implementations.

FIG. 2 is an illustration of an example method of generating geofences, in accordance with implementations.

FIG. 3 is an illustration of an example sequence of generating geofences, in accordance with implementations.

FIG. 4A is an illustration of an example sequence of segmenting an image, in accordance with implementations.

FIG. 4B is an illustration of an example sequence of creating cores, in accordance with implementations.

FIG. 5 is an illustration of a graphical user interface of interacting with geofences, in accordance with implementations.

FIG. 6 is an illustration of a graphical user interface of interacting with geofences, in accordance with implementations.

FIG. 7 is an illustration of an example method of identifying row bearings, in accordance with implementations.

FIG. 8 is an illustration of an example sequence of identifying row bearings, in accordance with implementations.

FIG. 9 includes geographical images of image sampling, in accordance with implementations.

FIG. 10 is an illustration of a sequence of overlaying a satellite image with a row bearing template, in accordance with implementations.

FIG. 11 is an illustration of row line segments overlaying a map, in accordance with implementations.

FIG. 12 is a block diagram illustrating an architecture of a computer system that can be employed to implement elements of the systems and methods described and illustrated herein, including, for example, the system depicted in FIG. 1 and the methods depicted in FIGS. 2 and 7.

### DETAILED DESCRIPTION

Following below are more detailed descriptions of various concepts related to, and implementations of, methods, apparatuses, and systems of tracking farm vehicle performance.

The various concepts introduced above and discussed in greater detail below may be implemented in any of numerous ways.

Farm management software can require accurate and holistic coverage of a farm owner's geofences. Inaccuracies in the geometry and representation of a customer's work areas can cause errors in calculated metrics and lead to incorrect operational insights. This can affect coverage analytics such as acreage and in-field operation time and can affect a user's ability to confidently monitor operations management.

A technical issue with relying on geofences for data collection and metric calculation is the reliance on pre-configuration of accurate geofence geometry and location for generating metrics that are useable by users. A recurring issue is work activities that occur outside known geofences are at high risk of going unreported.

A data processing system implementing the systems and methods described herein can identify areas in which work is performed within a geographical region but for which there is not a geofence to use to generate metrics of the work. The data processing system can generate (e.g., automatically generate) geofences outlining such areas. To do so, the data processing system can collect data from a data logger that is plugged into a farm equipment's automotive auxiliary power outlet, OBD II diagnostics connector, or J1939 connectors. Through the data logger, the data processing system can receive, via a cellular connection, collected data to be processed by the data processing system. In doing so, the data processing system can collect GPS data points to provide the ability to view and interact with real-time equipment GPS location updates and real-time trip information.

The data processing system can use density-based clustering techniques to cluster the GPS data points and classify the individual GPS data points as work activity, drive activity, or clustered activity. The data processing system can use the data point classifications to identify clusters of GPS data points to merge together. The data processing system can merge the identified clusters of GPS data points together based on the classifications (e.g., based on the clusters corresponding to a common line segment between GPS data points of the clusters with a common activity classification and/or based on the two clusters each having a GPS data point with a work classification). The data processing system can filter out clusters that do not include any GPS data points classified as work activity or that are within other previously generated geofences.

The data processing system can contour the areas surrounding the remaining clusters to generate one or more cores. The data processing system can filter the cores by modifying or clipping cores to avoid overlap with existing geofences. The data processing system can merge the cores with existing geofences, such as in cases in which the centers of the cores are within a defined distance of each other. The data processing system can provide an image with the center points of the cores into an image segmentation model to segment boundaries for the separate cores. The data processing system can generate geofence along the respective boundaries.

Subsequently, the data processing system can generate KPIs or other work-related data from data collected from the area within the geofence. Thus, the data processing system can use data collected from the data logger to generate geofences to facilitate the accurate generation of KPIs for work performed in areas for which the data processing system previously did not analyze data.

The data processing system can use the geofences that the data processing system generates to analyze work-related data that is generated from work within the respective geofences. For example, the data processing system can use the geofences to analyze key performance indicator (KPI) data from fieldwork performed within each geofence. The data processing system can generate such KPIs based on parameters of the geofence. Such parameters can include an identifier linking the geofence to specific field or farm records, a validated row bearing value for the enclosed area, timestamp data indicating when the geofence was created or last modified, flags indicating whether KPI analysis is permitted within the geofence based on row bearing validation status, associated crop type or growing season identifiers, or permitted operation types (e.g., planting, spraying, harvesting) within the geofence. The data processing system can use the parameters with location data of vehicles operating in the geofence to generate metrics during agricultural activities. This data includes: real-time equipment operational metrics (ground speed, engine RPM, implement status, fuel consumption rates), application data (seed populations, fertilizer rates, spray rates, chemical concentrations), harvest metrics (yield data, moisture content, biomass measurements), soil sampling results and field measurements (soil moisture, compaction readings, nutrient levels), operator behavior data (implement engagement patterns, turning behaviors, idle time), coverage metrics (overlap percentage, skip percentage, off-row operation percentage), equipment efficiency metrics (effective field capacity, field efficiency percentage, total operation time), and quality control measurements (planting depth consistency, spray pattern uniformity, harvest loss percentages).

However, the data processing system may not store accurate row bearings for each geofence. For example, the data processing system can automatically generate a geofence for an agricultural field (e.g., a field with rows of crops) using the process described above, but the geofence may not have a corresponding row bearing of the row of the agricultural field. In another example, a user can manually create a geofence for an agricultural field without providing a row bearing for the agricultural field.

In some cases, a computer can attempt to generate a row bearing for a geofenced agricultural field. In one example, the computer can do so using object recognition techniques on an image of the agricultural field. However, the row bearing may not be accurate due to a low resolution of the image. In another example, the computer can attempt to generate a row bearing of an area from an image by performing a Hough Transform on the image and using machine learning models that are trained to process such Hough Transforms. The transform operates by connecting pixels within an image (usually binary) to detect or extract regular features. However, such processing can be computationally expensive due to the large number of pixels and permutations of pixels that can be connected in any given image.

A data processing system implementing the systems and methods described herein can generate row bearings for geofences or other areas while overcoming these technical deficiencies. The data processing system can do so using a dual-pronged approach. For example, the data processing system can receive a request to generate a row bearing for an area bound by a selected geofence. Responsive to receiving the request, the data processing system can identify an image of a geographical region including an agricultural field bound by the selected geofence. The data processing system can also identify a plurality of global positioning system (GPS) data points from a device of each of one or more agricultural vehicles generated while the agricultural vehicles were operating in the agricultural field.

The data processing system can determine a first candidate row bearing for the agricultural field and selected geofence. To do so, for example, the data processing system can sample a portion of the image depicting the agricultural field into one or more (e.g., a plurality) of image samples. The image samples can each include a defined number of pixels depicting a different section of the agricultural field. For each image sample, the data processing system can identify a row bearing template (e.g., a two-dimensional sinusoidal grating template) that most closely matches the image sample. The identified row bearing templates can each correspond to a row bearing. The data processing system can determine the first candidate row bearing based on (e.g., as an average, circular average, or median of) the row bearings of the identified row bearing templates that match the image samples depicting the agricultural field.

The data processing system can determine a second candidate row bearing for the agricultural field and selected geofence. The data processing system can do so based on the GPS data points from the locations within the geofenced area. The data processing system can determine line segments for pairs of GPS data points that correspond to the same task or trip, such as a sprayer traveling down a row between crops. The data processing system can determine a line segment bearing for each line segment. The data processing system can determine the second candidate row bearing based on (e.g., as an average, circular average, or median of) the line segment bearings of the line segments.

The data processing system can use the first and second candidate row bearings to determine a row bearing for the geofence or agricultural field. For example, the data processing system can compare the first and second candidate row bearings to determine a circular difference between the two row bearings. As described herein, circular difference can mean circular difference or difference, but, for brevity, is referred to as one of circular difference or difference. The data processing system can compare the difference to a threshold. Responsive to determining the circular difference is below the threshold, the data processing system can determine the row bearing for the geofence or agricultural field to be a value determined based on both of the first and second candidate row bearings (e.g., the average, circular average, or median of the two candidate row bearings). In cases in which the circular difference exceeds the threshold, the data processing system can determine to use the second candidate row bearing determined based on the GPS data points as the row bearing for the agricultural field or geofence. The data processing system can do so because row bearings generated from GPS data points can be more accurate than row bearings generated from images, which can be the case because poor image quality can distort the angles of the rows depicted in images, for example.

The data processing system can store an association between the row bearing and the geofence or agricultural field. The data processing system may do so, for example, by storing the value of the row bearing and a flag indicating metrics can be generated from data generated within the geofence in a stored data structure for the geofences. In doing so, the data processing system can enable or facilitate the data processing system capability to generate accurate metrics or KPIs from data generated within the geofence or the agricultural field.

Advantageously, by implementing the systems and methods described herein with the dual candidate row bearings, the data processing system can generate a row bearing for a geofenced area or agricultural field more quickly and with more accuracy than systems that implement other methods. For example, the data processing system can avoid transforms, such as the Hough Transform, that can require accurate pre-processing of imagery to produce reliable results. This is a challenge to do well across various imagery sources and crop conditions given the variance in the resolution or quality of images that may be generated between imagery sources and/or of crops in different crop conditions. To mitigate this problem, other computing systems may use machine learning techniques for object recognition or image processing. However, using such machine learning techniques can require a large amount of processing power and can incur a significant amount of latency in the process. The data processing system can implement the systems and methods described herein to avoid such machine learning techniques and avoid identifying every object in an image of the geofenced area. Accordingly, the data processing system can operate to automatically generate accurate row bearings for geofences using fewer processing resources and more quickly than other systems.

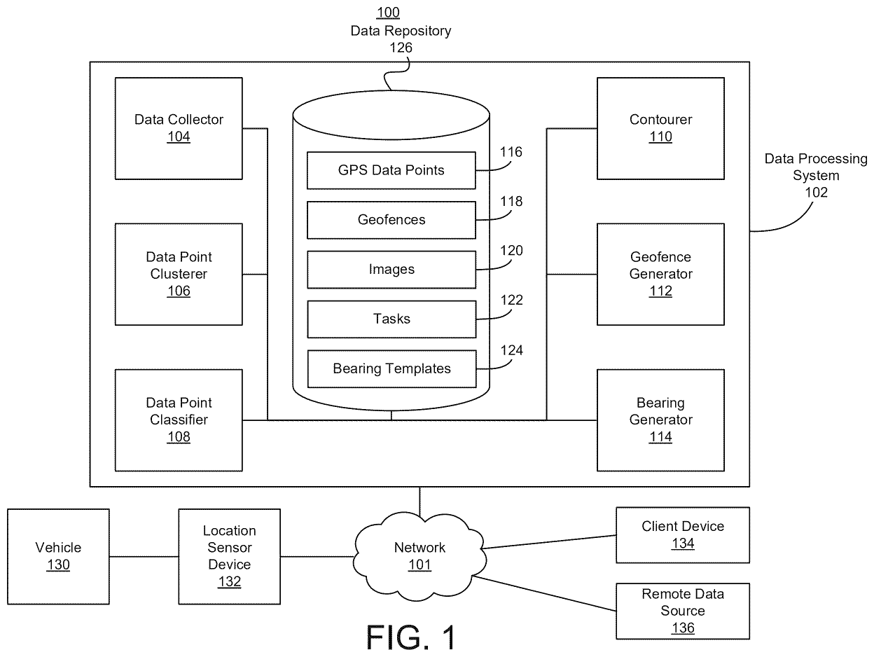

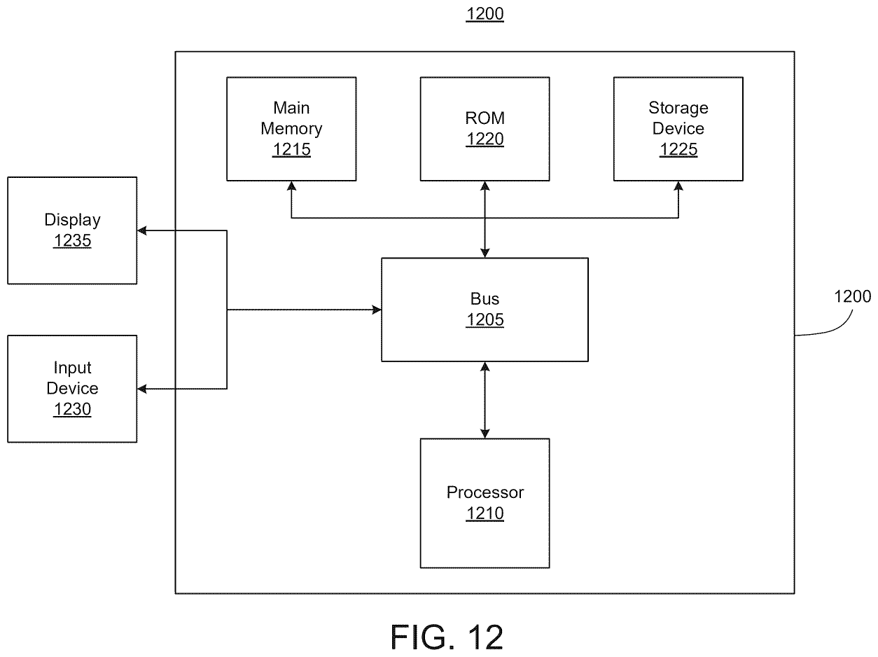

FIG. 1 illustrates an example system 100 for generating geofences and detecting row bearings, in accordance with some embodiments. The system 100 can include a data processing system 102. The data processing system 102 can communicate with one or more of a vehicle 130, a location sensor device 132, or a client device 134 via a network 101. The network 101 can include computer networks such as the Internet, local, wide, metro, or other area networks, intranets, satellite networks, and other communication networks such as voice or data mobile telephone networks. The network 101 can be used to transmit or receive information from various information resources, such as web pages, web-based applications, software-as-a-service applications, or servers that can be provided, output, rendered or displayed on at least one client device 134. The client device 134 can include, for example, a desktop computer, laptop computer, tablet computer, smart phone, mobile telecommunication device, or portable computer. The client device 134 or location sensor device 132 can include one or more components depicted in FIG. 12.

The network 101 can be any type or form of network and can include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 101 can include a wireless link, such as an infrared channel or satellite band. The topology of the network 101 can include a bus, star, or ring network topology. The network can include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data can be transmitted via different protocols, or the same types of data can be transmitted via different protocols.

The system 100 can include at least one data processing system 102. The data processing system 102 can include at least one logic device such as a computing device having a processor to communicate via the network 101, for example with the location sensor device 132 or client device 134. The data processing system 102 can include at least one computation resource, server, processor, or memory. For example, the data processing system 102 can include a plurality of computation resources or servers located in at least one data center. The data processing system 102 can be part of or include a cloud computing environment. The data processing system 102 can include multiple, logically-grouped servers and facilitate distributed computing techniques. The logical group of servers can be referred to as a data center, server farm or a machine farm. The servers can also be geographically dispersed. A data center or machine farm can be administered as a single entity, or the machine farm can include a plurality of machine farms. The servers within each machine farm can be heterogeneous—one or more of the servers or machines can operate according to one or more type of operating system platform.

Servers in the machine farm can be stored in high-density rack systems, along with associated storage systems, and located in an enterprise data center. For example, consolidating the servers in this way can improve system manageability, data security, the physical security of the system, and system performance by locating servers and high performance storage systems on localized high performance networks. Centralization of all or some of the data processing system 102 components, including servers and storage systems, and coupling them with advanced system management tools allows more efficient use of server resources, which saves power and processing requirements and reduces bandwidth usage.

The data processing system 102 can interface with, communicate with or otherwise access one or more location sensor devices 132. The location sensor device 132 can be associated with a vehicle 130. The location sensor device 132 can be located on the vehicle 130. The location sensor device 132 can be attached to the vehicle 130. The location sensor device 132 can be communicatively coupled or connected to the vehicle 130 via a communication port of the vehicle 130. The vehicle 130 can include one or more electronic connectors or ports. For example, the vehicle 130 can include an automotive auxiliary power outlet. The vehicle 130 can include an on-board diagnostic (“OBD”) port, such as an OBD-II port. An OBD-II can refer to or include an on-board computing that monitors emissions, mileage, speed, and other data associated with the vehicle 130. The OBD-II port can include a 16-pin port, for example. The vehicle 130 can include a J1939 connector, which can provide a high-layer protocol based on a controller area network. The J1939 connector can provide serial data communications between microprocessor systems.

The location sensor device 132 can include a location sensor, such as a global positioning system (“GPS”) sensor, cellular network triangulation device, wireless network-based location device, or other location device. In some cases, the location sensor device 132 can obtain location data from a location sensor built into the vehicle 130, in which case the location sensor device 132 can be referred to or include a data logger device.

The location sensor device 132 can be designed, constructed and operational to communicate with the data processing system 102 via the network 101. The location sensor device 132 can communicate location information or data logged from the vehicle 130 to the data processing system 102. The location sensor device 132 can receive instructions from the data processing system 102, receive request for information from the data processing system 102, or otherwise communicate with the data processing system 102. In some cases, the location sensor device 132 can be configured to run programs, scripts or routines provided by the data processing system 102 or otherwise established by an administrator or operator of the data processing system 102 or a farm.

The data processing system 102 can include, interface, or otherwise communicate with at least one data collector 104 (or data collector component). The data processing system 102 can include, interface, or otherwise communicate with at least one data point clusterer 106 (e.g., clustering component). The data processing system 102 can include, interface, or otherwise communicate with at least one data point classifier 108 (or classification component). The data processing system 102 can include, interface, or otherwise communicate with at least one contourer 110 (or contouring component). The data processing system 102 can include, interface, or otherwise communicate with at least one geofence generator 112 (or geofence generation component). The data processing system 102 can include, interface, or otherwise communicate with at least one bearing generator 114 (or bearing generation component). The data processing system 102 can include, interface, or otherwise communicate with at least one data repository 126.

The data collector 104, data point clusterer 106, data point classifier 108, contourer 110, geofence generator 112, and bearing generator 114 can each include at least one processing unit or other logic device such as programmable logic array engine, or module configured to communicate with the data repository 126 or database. The data collector 104, data point clusterer 106, data point classifier 108, contourer 110, geofence generator 112, and bearing generator 114 can be separate components, a single component, or part of the data processing system 102. The system 100 and its components, such as a data processing system 102, can include hardware elements, such as one or more processors, logic devices, or circuits.

The data repository 126 can include one or more local or distributed databases, and can include a database management system. The data repository 126 can include computer data storage or memory and can store one or more of global positioning system (GPS) data points 116, geofences 118, images 120, tasks 122, or row bearing templates 124.

The GPS data points 116 can refer to or include location data points received from the vehicles 130. The GPS data points 116 can include location data points received from vehicles 130. The GPS data points 116 can include historical location data points received from location sensor devices 132 and associated with a customer.

The geofences 118 can include identifications of different defined geofences. The geofences 118 can each correspond to a different identification or location information (e.g., coordinates or other types of GPS data) identifying locations or outlines of the respective geofences 118. The images 120 can be or include overhead images, such as satellite imagery of different geographic regions.

Within the data processing system 102, geofences can represent the boundaries of the individual fields or work areas within a larger agricultural property. Geofences can allow the data processing system 102 to isolate the GPS data points 116 and other sensor information to the specific field or work area being analyzed. Using geofences, the data processing system 102 can extract relevant data like row bearings, vehicle travel paths, and work activities that are specific to each individual field to generate work-related data or key performance indicators (KPIs). Geofences can provide a way to organize and analyze the data in a structured manner, rather than trying to process all the sensor data for the entire property at once. Thus, geofences can facilitate the data processing system 102's capability to accurately track and report on the work being done in distinct fields or areas.

The tasks 122 can include different types of task data structures. For example, the tasks 122 can include a trip task data structure. A trip task data structure can include metrics determined by the data processing system and used to display via the client device 134.

An example trip task data structure can include:

```
  “data”: {
    ‘uid’: 619782,
    ‘starttime’: datetime.datetime(2025, 1, 31, 21, 31, 35,181211,
tzinfo=datetime.timezone.utc),
    ‘endtime’: datetime.datetime(2025, 1, 31, 21, 31, 38,890243,
tzinfo=datetime.timezone.utc),
    ‘vehiclesn’: ‘b8058eb5fe90’,
    ‘intelliblocknum’: 1,
    ‘taskId’: ‘37823’,
    ‘implementsn’: ‘eb544g1’,
    ‘distance’: 0.0093520194341297,
    ‘duration’: 0.001030166666667,
    ‘inbuffer’: True,
    ‘userid’: ‘’,
    ‘gpsdata’: [{‘speed’: 1, ‘datetime’:‘2025-01-31T21:31:36.125+00:00’, ‘latitude’:
37.24114, ‘augmented’: False,‘longitude’: −121.468116, ‘vehiclesn’: ‘ b8058eb5fe90’,
‘intelliblocknum’: 1},...}
```

In some cases, the data repository 126 or a different data repository can store task configurations for different tasks. The task configurations can store or include different parameters for specific types of tasks. Trip task data structures or data structures for task events be linked to the task configurations by a task identifier (e.g., taskId). An example task configuration is as follows:

```
“data”: {
  id: “3243260869”,
  coll: TaskConfigs,
  ts: Time(“2025-02-12T20:54:47.410Z”),
  name: “Spraying”,
  taskId: “37823”,
  width: 0,
  archived: true,
  rowApplicationType: 0,
  applicationRows: 0,
  enableAcreageCapping: false,
  avgSpeedTarget: 5,
  acPerHrTarget: 0,
  defaultReiHours: “”,
  cycleDays: “”,
  enableSpeedVisualization: true,
  speedTargetMinKph: 4.5,
  speedTargetMaxKph: 5.5
}
```

As illustrated, the example trip task data structure can be linked with the task configuration for a “Spraying” task by the common taskID of “37823.” In some cases, the data processing system 102 system can identify types of trip data structures (e.g., tasks 122) for specific task events that correspond to specific types of tasks by identifying trip data structures that correspond to or contain taskIDs of task configurations that contain specific names or key words. For instance, the data processing system 102 can identify task events associated with spraying or harvesting by identifying the task configurations containing the word spraying or harvesting, identifying the taskID of the identified task configurations, and identifying the task event data structures that contain the identified taskIDs. Accordingly, the data processing system can use the task configurations to quickly identify events of a defined task type with low latency compared with systems that identify the types of tasks events on a task event-by-task event basis.

The row bearing templates 124 can include two-dimensional sinusoidal grating templates. The row bearing templates 124 can each include straight or sinusoidal lines at different angles. For example, one row bearing template can include lines (e.g., striped lines) at a five degree angle and another row bearing template can include lines at an eight degree angle. The row bearing templates 124 can be stored with associations with angles of the lines depicted on the templates. The row bearing templates 124 can additionally or instead depict lines with other parameters, such as frequency, or phase.

The row bearing templates 124 can each correspond to or be stored with a row bearing (e.g., line angle). The corresponding row bearings can be the angles of the lines depicted on the respective row bearing templates 124. A row bearing can be the orientation or direction of crop rows within an agricultural field. Specifically, a row bearing can be or include the angle or bearing of a parallel row of crops. A row bearing can be measured in degrees relative to a reference direction (e.g., north).

In some cases, the bearing generator 114 can generate the row bearing templates 124 at each instance that the data processing system 102 operates to generate a row bearing for a geofence. For example, the data repository 126 may not store bearing templates 124 over time. Instead, the bearing generator 114 can generate the bearing templates 124 at each instance that the bearing generator 114 generates or determines a row bearing for a geofence and discard the bearing templates 124.

The data processing system 102 can include an interface (or interface component) designed, configured, constructed, or operational to communicate with the client device 134 or location sensor device 132. The interface can receive and transmit information using one or more protocols, such as a network protocol. The interface can include a hardware interface, software interface, wired interface, or wireless interface. The interface can facilitate communication between one or more components of the data processing system 102. The interface can include or provide a user interface, such as a graphical user interface or frontend user interface. The interface can provide the user interface or access to a frontend interface via client device 134.

The data processing system 102 can include a data collector 104 designed, constructed, and operational to receive, collector, identify, or otherwise obtain data. The data collector 104 can obtain data from one or more devices via the network 101, including, for example, the location sensor device 132, a data logger, the client device 134, or a remote data source 136. The data collector 104 can receive data or information in any format, such as a hypertext markup language (“HTML”), comma-separated values (e.g., .CSV), an open extensible markup language (“XML”) spreadsheet (e.g., XLSX), images, vector-based maps, or a portable document format file (e.g., PDF).

The data collector 104 can receive data files comprising geospatial coordinates associated with a geographic area. The data collector 104 can receive the data file from an operator or manager of a farm via the client device 134. For example, the operator of the farm can generate, maintain or store the data file, and provide the data file to the data processing system 102. The geographic area can correspond to a farm. The data file can include or be a shapefile. A shapefile can refer to a nontopological format for storing the geometric location and attribute information of geographic features. Geographic features in a shapefile can be represented by points, lines, or polygons (e.g., areas). The shapefile format can include a geospatial vector data format for geographic information system (GIS) software. The shapefile format can spatially describe vector features: points, lines, and polygons, representing, for example, farm boundaries.

The data collector 104 can receive information from a remote data source 136. The remote data source 136 can include an online resource or other data resource. The remote data source 136 can include, for example, a map data repository or map service. The remote data source 136 can provide geographic information associated with satellite-based imagery or street-based mapping imagery.

The data collector 104 can receive data from location sensor device 132 or a data logger connected to the vehicle 130. The data collector 104 can receive location data points from the location sensor device 132. The data collector 104 can receive information corresponding to the vehicle 130, farm, or customer. For example, the location sensor device 132 can establish a communication session with the data processing system 102 or data collector 104 during which the location sensor device 132 can provide authentication credentials or other information that identifies the customer or farm. The data collector 104 can associate a username, user identifier, customer identifier, or other unique authenticating information with the location data points. The data collector 104 can store the received location data in the GPS data point 116. The data collector 104 can store other logged data received from the location sensor device 132 or data logger device in the data repository 126, such as in the tasks 122 data structure.

The data collector 104 can store received data in the data repository 126 for future processing, or provide the received data to one or more component of the data processing system 102 for further processing or real-time processing.

The data processing system 102 can include a data point clusterer 106 designed, constructed, and operational to cluster GPS data points 116. The data point clusterer 106 can implement one or more clustering algorithms to group GPS data points 116 together based on spatial proximity and temporal relationships. For example, the data point clusterer 106 can implement or execute a density-based spatial clustering of applications with noise (DBSCAN) algorithm to identify clusters of GPS data points 116 with sufficient density (e.g., density above a threshold). The DBSCAN algorithm can determine (e.g., automatically determine) the number of clusters and identify outliers, making it particularly suitable for trajectory analysis. In some cases, the data point clusterer 106 can use hierarchical clustering methods to create a nested hierarchy of point clusters, or implement a modified k-means algorithm configured for spatiotemporal data. The clustering parameters, such as minimum points per cluster and maximum distance between points, can be dynamically adjusted based on the specific requirements of the application, such as urban versus rural environments or different modes of transportation.

The data point clusterer 106 can cluster GPS data points 116 in a particular region. For example, the data point clusterer 106 can identify one or more GPS data points 116 that correspond to a farm or agricultural field of a customer. The data point clusterer 106 can identify the one or more GPS data points 116 in response to a request from a computing device (e.g., the client device 134). For example, a user at the computing device can submit a request to the data processing system 102 identifying a geographical region (e.g., a farm owned by the user or the user's organization or company). The request can be a request to generate a geofence in which work is performed but that the data processing system 102 does not currently store in the data repository 126. In response to the request, the data point clusterer 106 can retrieve GPS data points 116 that are within the geographical region from the data repository 126. The data point clusterer 106 can cluster the retrieved GPS data points 116 together using a clustering algorithm such as DBSCAN or k-means clustering. In some cases, the data point clusterer 106 may only retrieve or cluster GPS data points 116 generated for a particular vehicle or particular vehicles, customer, or time period, which may be indicated in the request.

The data point clusterer 106 may filter the GPS data points 116 based on the vehicle from which the GPS data points 116 were generated. In some cases, the data point clusterer 106 may do so prior to clustering the GPS data points 116 to conserve processing resources and reduce latency in generating the new geofences or generating a response to the request. To do so, the data point clusterer 106 can identify the number of GPS data points 116 each vehicle provided of the retrieved GPS data points 116 for the geographical region. The data point clusterer 106 can compare the numbers to a threshold (e.g., 100). Based on the comparisons, the data point clusterer 106 can identify vehicles that provided fewer than the threshold number of GPS data points 116. The data point clusterer 106 may remove or discard the GPS data points 116 provided by vehicles that provided less than the threshold number of GPS data points. By doing so, the data point clusterer 106 can avoid using data points from vehicles that may provide inaccurate work related data, such as because they are new to the geographical region.

The data point clusterer 106 can additionally or instead filter out the clusters of GPS data points 116. The data point clusterer 106 can do so based on whether the clusters of GPS data points intersect with existing geofences 118. For example, the data point clusterer 106 can generate a hull for each of the clusters. The data point clusterer 106 can do so, for example, when using DBSCAN for the clustering or otherwise by generating a rectangle or polygon that is large enough to encompass each GPS data point 116 of the cluster. The data point clusterer 106 can determine if the hull intersects with the boundaries of any existing geofences 118. The data point clusterer 106 can discard any clusters for which the data point clusterer 106 determines the hull of the cluster intersects with a boundaries of an existing geofence 118. In doing so, the data point clusterer 106 can reduce the number of clusters of data points for processing when generating new geofences.

The data point clusterer 106 can determine line segments that correspond to the clustered GPS data points 116. The data point clusterer 106 can do so in one of a few manners. In one example, the GPS data points 116 can be stored with trip identifications or task identifications of tasks that are stored in the tasks 122 data structure. The trip or task can include or correspond to a subset of GPS data points indicating the locations of a vehicle as the vehicle was performing the task over time. Together, the subsets of GPS data points can each correspond to a line segment for the task or trip. The initial GPS data point (e.g., the GPS data point with the earlier or earliest timestamp or a flag identifying the GPS data point as the initial data point) can be the start GPS data point 116 and the last or subsequent GPS data point (e.g., the GPS data point with the later or latest timestamp or a flag identifying the GPS data point as the last or final data point) of the task or trip can be the end point GPS data point 116. The data point clusterer 106 can identify line segments for the clustered GPS data points by identifying the line segments of the tasks or trips of which the GPS data points 116 are a part. In another example, the data point clusterer 106 can determine line segments for pairs or subsets of GPS data points 116 based on the GPS data points corresponding to sequential time stamps and being generated at or by the same vehicle. The data point clusterer 106 can generate the line segments in any manner.

The data processing system 102 can include a data point classifier 108 designed, constructed, and operational to classify or otherwise assign classifications to GPS data points 116. The data point classifier 108 can classify GPS data points before or after the GPS data points have been clustered. The data point classifier 108 can be configured to classify GPS data points 116 into distinct activity classes including drive activity, work activity, and clustered activity. Work activity GPS data points can be GPS data points that are generated when a vehicle is actively performing farm work (e.g., plowing, harvesting, spraying, etc.). Drive activity GPS data points can be GPS data points that are generated when a vehicle is driving between locations without actively performing farm work (e.g., driving from one field to another. Clustered activity GPS data points can be GPS data points that are generated when a vehicle is performing a non-driving activity or work activity, such as when the vehicle is idling or parked in a specific location, making repeated movements in a confined area (like loading/unloading), or performing activities that create a cluster of GPS points in one area.

The machine learning model of the data point classifier 108 used to classify the data points can be a neural network, a transformer, a support vector machine, a random forest, etc. The machine learning model can be configured or trained to generate confidence scores for the activity classifications of work activity, drive activity, or clustered activity for individual data points based on a timeseries of GPS data points around the respective GPS data points and/or metadata of the GPS data points. The metadata of the GPS data points can include any combination of indications of whether the data points are start points (e.g., start data points) or end points (e.g., end data points), indications of the clusters assigned to the GPS data points 116 (e.g., after the merging), length of the line segments of which the GPS data points 116 are a part, the bearings of the line segments, etc. The machine learning model or the data point classifier 108 can determine or assign activity classifications to individual GPS data points 116 responsive to determining or identifying a confidence score for an activity classification for each GPS data point 116 exceeds a threshold, for example.

The machine learning model can be trained using supervised, semi-supervised, or unsupervised learning techniques. For example, the machine learning model can be trained using a labeled training data set that includes individual GPS data points, a time series of GPS data points generated by or at the same vehicle as the respective GPS data points prior to or after each respective GPS data point, or metadata of the respective GPS data points. Each GPS data point can be labeled with the correct or ground truth activity classification. The data processing system 102 can feed the labeled training data set into the machine learning model and execute the machine learning model to cause the machine learning model to generate predicted activity classifications for the respective GPS data point classifications. The data processing system 102 can use backpropagation techniques with a loss function to adjust the internal weights or parameters of the machine learning model based on the differences between the predicted activity classifications for the GPS data points and the labels for the respective GPS data points. The data processing system 102 can repeat this process over time until determining the machine learning model is accurate to an accuracy threshold. Responsive to determining the machine learning model is accurate to the accuracy threshold, the data processing system 102 can deploy (e.g., begin using) the machine learning model for inference.

The data point classifier 108 can use the machine learning model to classify each of the clustered GPS data points 116 of the geographical region. The data point classifier 108 can do so, for example, by providing the respective GPS data points 116 into the machine learning model with one or more GPS data points (e.g., a timeseries of GPS data points) generated by the same vehicles of the GPS data points before or after the respective GPS data points or metadata of the GPS data points. The data point classifier 108 can execute the machine learning model based on the input to cause the machine learning model to classify the individual GPS data points. In doing so, the data point classifier 108 can assign the classifications of work activity, drive activity, or clustered activity to each of the clustered GPS data points 116. The data point classifier 108 can store associations between the assignments and the clustered GPS data points 116 in memory.

The data point clusterer 106 can use the classifications of the clustered GPS data points 116 to refine the clusters of GPS data points 116. The data point clusterer 106 can do so using one or more criteria. For example, the data point clusterer 106 can determine to merge a pair of clusters that meet one or at least a defined number or set of the following criteria: (1) one or a defined number of line segments exist between the two clusters with a start point GPS data point in one of the two clusters and an end point GPS data point in the other of the two clusters, (2) the activity classification for the start point GPS data point and the end point GPS data point is the same, and (3) dividing the area containing both clusters into equal squares shows a distribution (e.g., portion between squares) exceeding a threshold in connection points vs. concentration of connections, where a connection is or can be a GPS data point 116, such as a GPS data point 116 that is a part of a line segment.

The data point clusterer 106 can determine whether a line segment exists between the two clusters by scanning the start point GPS data points 116 and end point GPS data points 116 of the clusters of GPS data points 116. The data point clusterer 106 can scan through the line segments of clustered GPS data points 116 and identify line segments with start point GPS data points in clusters of GPS data points different than the clusters of the end point GPS data points. The data point clusterer 106 can instantiate a counter for each pair of clusters that the data point clusterer 106 identifies with a start point GPS data point 116 in one cluster and an end point GPS data point in the other cluster. For a pair of clusters, the data point clusterer 106 can increment the counter for each line segment between the pair of clusters that begins in one cluster and ends in the other cluster. The data point clusterer 106 can repeat this process for each identified line segment and compare the count of the counter with a threshold with each increment. Responsive to determining the count of the counter exceeds or otherwise satisfies the threshold, the data point clusterer 106 can determine the criterion relating to determining whether a defined number of line segments exist between the two clusters.

The data point clusterer 106 can determine whether the classification for the start point GPS data point and the end point GPS data point is the same for a pair of clusters by identifying the classification of the start point and end point GPS data points of the line segments between the two clusters. In some cases, the data point clusterer 106 may only increment the counter described above for the line segments that satisfy this criterion. In some cases, the data point clusterer 106 can instantiate a separate counter for the pair of GPS data points and increment the counter for each line segment with a matching classification.

In some cases, the data point clusterer 106 only increments one of the counter responsive to the activity classification being of a certain type. For instance, the data point clusterer 106 may only increment the counters responsive to identifying line segments with matching start point and ending data points of a work activity type.

The data point clusterer 106 can determine whether there is an equal or substantially equal distribution of connections of GPS data point between clusters by dividing the area containing both clusters into equal squares (e.g., squares of the same area) and determining a distribution of GPS data points of the two clusters within the squares. For example, if a GPS data point 116 from a first cluster connects via a line segment to a GPS data point 116 in a second cluster, both GPS data points 116 serve as connection points. The data point clusterer 106 can determine the portion of connection points present in each square relative to the total number of connection points in the divided area. When the portion exceeds a predetermined threshold across at least a defined number or portion of squares of the region, the data point clusterer 106 can determine the clusters exhibit sufficient spatial connectivity to be merged.

This distribution analysis can distinguish between clusters connected by broadly distributed work patterns versus clusters connected by narrow transit paths.

By classifying GPS data points and using the classifications to filter out or merge clusters, the data processing system 102 can increase the accuracy of the geofences that the data processing system 102 generates. For instance, the classifications can facilitate the data processing system 102 only generating new geofences in non-geofenced areas but in which work is performed. Thus, the data processing system 102 can use the classifications to avoid generating geofences that cover areas in which work is not performed. By doing so, the data processing system 102 can limit the data collection and processing to only relevant data for generating field-work related metrics, which can substantially increase processing speed and reduce the memory requirements of generating metrics or other data from data generated within stored geofences.

In some cases, the data point clusterer 106 can filter out potential merge cluster candidate. The data point clusterer 106 can do so based on GPS data points 116 classified as drive activity. For example, the data point clusterer 106 can identify the GPS data points 116 between a pair of clusters and classifications of the identified GPS data points 116. The data point clusterer 106 can identify the GPS data points 116 between the clusters (e.g., outside of bounds of the respective clusters characterized by outermost GPS data points 116 of the respective clusters) classified as drive activity. The data point clusterer 106 can instantiate and increment a counter for each such GPS data point 116. Responsive to determining the number of GPS data points 116 indicated by the counter exceeds a threshold, the data point clusterer 106 can stop processing the pair of clusters as merging candidates.

The data point clusterer 106 can merge each pair of clusters that satisfies the criteria listed above or any other criteria that the data point clusterer 106 is configured to use for merging. To merge the two clusters, the data point clusterer 106 can assign new labels to one or both of the GPS data points 116 identifying the merged cluster. The labels can be for one of the clusters of the merged cluster or can be a new label for the merged cluster. For example, the data point clusterer 106 can merge a cluster A with a cluster B with GPS data points 116 labeled A or B, respectively. The data point clusterer 106 can merge the clusters by changing the labels of the GPS data points 116 such that each GPS data point 116 is labeled with an A or each GPS data point 116 is labeled with a B or such that each of the GPS data points 116 are labeled with a new label, such as AB. The data point clusterer 106 can similarly merge any number of pairs of clusters in this manner.

In some cases, the data point clusterer 106 can merge previously merged clusters. For example, the data point clusterer 106 can merge one or more pairs of clusters and then repeat the merging process by applying the criteria described above using the merged clusters or the remaining unmerged clusters. In doing so, the data point clusterer 106 can merge pairs of merged clusters or pairs of clusters that include one merged cluster and one unmerged cluster.

The data point clusterer 106 can repeat this process for any number of iterations, such as for a defined number of iterations or until determining no more clusters satisfy the criteria to be merged. In doing so, the data point clusterer 106 can create or generate a list of clusters of GPS data points that can be used to generate geofences. The data point clusterer 106 can store the data points with metadata for the clustered GPS data points 116. For example, the metadata can include indications of whether the data points are start points (e.g., start data points) or end points (e.g., end data points), indications of the clusters assigned to the GPS data points 116 (e.g., after the merging), length of the line segments of which the GPS data points 116 are a part, the bearings of the line segments, the predicted activity categories of the GPS data points 116, etc. The data point clusterer 106 can store such metadata in the data repository 126.

The data point clusterer 106 can filter or remove clusters from consideration for use for generating geofences. The data point clusterer 106 can do so using one or more filtering criteria. For example, the data point clusterer 106 can retrieve a set of geofences 118 from the data repository 126 that correspond to (e.g., are located in) the geographical region for which the data processing system is generating geofences. The data point clusterer 106 can identify such geofences by identifying the locations or coordinates of the geographic region and identifying the geofences in the data repository 126 can correspond to locations in the geographic region. The data point clusterer 106 can identify the locations (e.g., coordinates) of the clustered GPS data points 116 and determine if the locations are within one of the retrieved set of geofences of the geographic area. Responsive to determining at least one or a defined number of GPS data points 116 are within one or more of the geofences 118, the data point clusterer 106 can remove one or more of the clusters of the determined GPS data points 116 from the list of clusters to potentially be used to generate geofences.

In some cases, instead of or in addition to filtering clusters based on the locations of individual GPS data points 116 or contours of the clusters, the data point clusterer 106 can use the centroids of the clusters for the filtering. For example, the data point clusterer 106 can determine or calculate the centroid of each of the clusters, such as by determining an average or median location for each cluster. The data point clusterer 106 can determine if the centroid is within the geographic region of one of the retrieved set of geofences. The data point clusterer 106 can filter or remove from the list of clusters each cluster for which the data point clusterer 106 determines the centroid of the cluster is within at least one of the retrieved set of geofences 118.

The data point clusterer 106 can remove or filter clusters based on the activity classifications of the clusters. For example, the data point clusterer 106 can identify the classifications of the GPA data points 116 of the clusters. The data point clusterer 106 can remove or filter any clusters that do not have at least one or another defined number of work activity data points. In doing so, the data point clusterer 106 can avoid creating geofences in areas where work-related activity is not performed. The data point clusterer 106 can filter clusters based on any filtering criteria being satisfied.

The data processing system 102 can include a contourer 110 designed, constructed, and operational to contour the area around individual clusters. The contourer 110 can process the GPS data points 116 to generate refined boundary representations of work areas through a multi-step contouring process. For example, the contourer 110 can filter line segments of GPS data points 116 within individual clusters based on length and bearing characteristics. In doing so, the contourer 110 can filter or remove short line segments below a minimum threshold, such as below 25 meters, which can eliminate noise and non-significant movements. Additionally or instead, the contourer 110 can identify dominant bearings in the movement patterns (e.g., up to a defined number, such as up to three, of the most common bearings of the line segments, as indicated in the metadata of remaining clustered GPS data points 116 or remaining line segments of the GPS data points 116) and retain line segments that are within a specified angular tolerance, such as 20 degrees, of these dominant bearings.

After filtering the line segments, the contourer 110 can apply Delaunay triangulation to the remaining clusters to create a mesh of triangles for each of the clusters. For each triangle in the mesh, the contourer 110 can calculate and store multiple geometric metrics. These metrics can include the original triangle geometry, a reduced-size version of the triangle, the number of filtered line segments intersecting the triangle, the triangle's area, a rectangularity score indicating how closely the triangle approximates a rectangular shape, and the maximum distance between any intersecting line and the triangle's furthest vertex, for example.

The contourer 110 can evaluate the triangles based on statistical and geometric criteria. For example, the contourer 110 can calculate the 25th and 75th percentiles (or any other defined percentiles) of the maximum vertex distances and select triangles that fall within these quantile bounds. Additionally, the contourer 110 can apply one or more threshold filters to retain only triangles with a rectangularity score exceeding a value (e.g., 0.35) and containing more than a defined number (e.g., two) line segment intersections. These criteria can be used to identify triangles that represent areas of consistent work activity.

For the filtered line segments, the contourer 110 can generate bounding boxes to establish rough boundaries of work areas. The contourer 110 can then merge the selected triangles that passed the evaluation criteria into larger polygons and apply simplification algorithms to smooth and regularize the polygon boundaries. The contourer 110 can validate the geometric integrity of these merged polygons to ensure they remain topologically valid and representative of the underlying work activity.

For example, the contourer 110 can process the filtered line segments by first generating bounding boxes that establish preliminary work area boundaries. The contourer 110 can generate the bounding boxes to encompass the filtered line segments and/or with a defined margin for subsequent refinement. The contourer 110 can evaluate each bounding box to ensure the bounding box meets minimum dimensional requirements and maintains appropriate spacing from adjacent bounding boxes (e.g., bounding boxes generated from GPS data points 116 of other clusters), thereby preventing overlap and ensuring discrete work areas are properly segregated.

The contourer 110 can merge the selected triangles that satisfy the initial filtering criteria into consolidated polygons. The contourer 110 can do so, for example, by employing geometric union operations to combine adjacent triangles sharing common edges. Following the triangle merging, the contourer 110 can apply one or more simplification algorithms to the polygon boundaries, reducing the number of vertices while preserving the essential shape characteristics of the work areas. This simplification process can include smoothing operations that eliminate sharp angles and irregularities, resulting in more uniform and practical boundary definitions. Throughout this process, the contourer 110 can continuously validate the geometric integrity of the merged polygons, checking for topology violations such as self-intersections or invalid vertex arrangements, and applying corrective measures when necessary to maintain valid and representative work area boundaries.

In cases in which a merged polygon fails geometric validation or is too small to capture the cluster's activity pattern, the contourer 110 can substitute the polygon with its corresponding bounding box (e.g., the bounding box generated from the filtered line segments). The contourer 110 can generate a set of core objects (also described herein as cores) that can each include either of the validated polygons or bounding boxes and that represent distinct areas of work activity identified from the remaining clusters. These cores can operate as target areas for subsequent image segmentation processing. The contourer 110 can generate the core to have a boundary of the perimeter of the selected triangles.

To refine or identify the boundaries of cores, the contourer 110 can identify exclusion points extracted from the polygons of existing geofences 118. The contourer 110 can do so, for example, by creating an inward offset of the existing geofence boundaries and sampling (e.g., identifying the locations of) points at regular intervals along these offset boundaries or the areas within the offset boundaries. These exclusion points can help prevent the generated cores from overlapping with known work areas.

For each core (e.g., core object), the contourer 110 can retrieve corresponding satellite images of the area around the core and perform coverage validation tests. The contourer 110 can generate a preliminary segmentation mask of the geographic region or the areas around the generated cores. The contourer 110 can determine or identify any preliminary segmentation masks that extend beyond the image boundaries, indicating a “blow-out” condition. When such conditions are identified, the contourer 110 can adjust the images, such as a zoom level or image dimensions, and repeat the segmentation masking process. The contourer 110 can repeat this process until determining the preliminary segmentation mask covers (e.g., covers at least a defined percentage of) the geographical region or the areas around the respective cores.

The contourer 110 can execute (e.g., via an application programming interface (API)) an image segmentation model (e.g., the segment anything model (SAM)) to segment the cores and images. The contourer 110 can do so, for example, using each core's center point or centroid as a prompt or input with the images of the areas around the respective cores. In some cases, the contourer 110 can rearrange the cores in a list of cores by size such that the smallest cores (e.g., the cores of the smallest clusters or clusters with the smallest number of GPS data points 116) are used in the prompt first. The contourer 110 can execute the image segmentation model based on the prompts and images of the geographic region (e.g., the preliminary segmentation masks generated for the respective cores or the image of the geographic region) to cause the image segmentation model to generate a segmentation mask (e.g., a binary segmentation mask identifying pixels or locations that correspond to the geofence or not). In some case, the contourer 110 can include the exclusion points in the prompt that the contourer 110 can use to avoid segmenting the new geofence at locations that intersect with previously existing geofences 118. The contourer 110 can convert the image segmentation mask into a polygon object with geospatial metadata (e.g., an identification of the location or coordinates of the polygon).

For each core, the contourer 110 can perform one or more association or validation checks. For example, the contourer 110 can determine a spatial proximity between the core or geofence generated from the core and one or more previously generated geofences 118 or whether there is any overlap between the segmentation mask generated for the core and any of the geofences 118. Responsive to determining the core (e.g., boundary of the core or center of the core) or geofence is too close to (e.g., within a threshold distance of) one or more previously generated geofences 118, the contourer 110 can determine to merge the geofence with the geofence or geofences that are within the threshold distance. Responsive to determining there is an overlap between the segmentation mask of the core (e.g., the boundaries of the geofence generated from the core) and one or more geofences, and in some cases responsive to determining the core or geofence is not too close with the previously existing geofence 118, the contourer 110 can modify the segmentation mask (e.g., the geofence) for the core to align or border the previously overlapping geofence such that the contourer 110 can generate a contour of the geofence at the boundaries of the previous geofence. In some cases, the overlap or the determination that the core or geofence is too close to the other existing geofence 118 can cause the contourer 110 to discard or filter the cluster of the core from consideration for generating a new geofence (e.g., discard the geofence of the segmentation mask).

In some cases, after modifying the segmentation mask, the contourer 110 can determine if the segmentation mask is a valid geometric object and has a size exceeding a threshold, such that the core can serve as a prompt into the image segmentation model. The contourer 110 can do so by comparing the shape to stored shapes and memory and determining to determine if the segmentation mask matches (e.g., matches within a threshold of) one or more of the stored shapes. Responsive to determining the size of the segmentation mask does not exceed the threshold or the shape of the segmentation mask does not match any stored shapes, the contourer 110 can generate an alert indicating the core is an error and store a flag with the core indicating not to use the core to generate any geofences.

Another example of validating the individual cores can include determining whether the cores correspond to an inaccurate image segmentation mask (e.g., an image segmentation with an accuracy below an accuracy threshold). The contourer 110 can determine the accuracy of the segmentation of a core using a second machine learning model configured for contouring by comparing the contouring for the core generated by the second machine learning model with the image segmentation model that generated the segments of the core. Responsive to determining has an accuracy below the accuracy threshold, the contourer 110 can retrieve a second image of the area around the core and repeat the process to determine whether a geofence can be generated from the core using a different image. The contourer 110 can repeat this process any number of times until identifying an image for which the contourer 110 can generate an accurate segmentation for the core or determining no further images are available for segmenting of the area. The contourer 110 can stop attempting to generate a geofence responsive to determining no further images are available and/or generate an alert at a user interface (e.g., a user interface display at the client device 134) indicating a geofence could not be generated for the area.

The data processing system 102 can include a geofence generator 112 designed, constructed, and operational to generate geofences in the contours of the respective cores. To do so, the geofence generator 112 can identify the contouring generated for each of the remaining cores after the contourer 110 filtered out any cores and generated contours of the areas surrounding the cores, taking into account the surrounding geofences or the accuracy of the segmentation. To generate the geofences, the geofence generator 112 can generate an identifier for each geofence and store the geographic locations of the geofences in memory with the identifiers of the respective geofences. The geofence generator 112 can store geofences (e.g., identifications of the geofences and/or boundaries of the geofences) in the data structure of the data repository 126 that stores the geofences 118.

In some cases, the geofence generator 112 can perform a second check with the previously generated geofences to determine whether to modify or merge the newly generated geofences based on a previously generated geofence. To do so, the geofence generator 112 can determine whether the outlines of the geofences overlap with any of the previously generated geofences 118. Responsive to determining a new geofence overlaps a previously generated geofence, the geofence generator 112 can perform one of (1) merge the new geofence with the overlapping geofence, (2) modify the boundary of the geofence, such as by clipping the geofence, to border the previously overlapping geofence, or (3) clipping or modifying the previously stored geofence overlapping the newly generated geofence. The geofence generator 112 can select which of these actions to perform, for example, based on the configuration of the geofence generator 112. The geofence generator 112 can similarly generate or modify geofences for any number of cores generated or identified for the geographical region.

The geofence generator 112 can present the geofences on a user interface. For example, the geofence generator 112 can retrieve an overhead image (e.g., a satellite image) of the geographical region. The geofence generator 112 can overlay outlines of the newly generated geofences on the overhead image at the locations of the overhead image that correspond to the locations for which the geofence generator 112 generated the geofences. In some cases, the geofence generator 112 can include outlines of the previously generated geofences on the image. In some cases, the geofence generator 112 can include the GPS data points 116 that were used to generate the clusters and geofences. The geofence generator 112 can present the overlaid image on a user interface, such as on a display of the client device 134 (e.g., in response to the request to generate one or more geofences of the geographical region from the client device 134).

In some cases, the geofence generator 112 can determine a confidence level in the generated geofences using the overlaid image. The geofence generator 112 can do so using a machine learning model (e.g., a neural network, such as a convolutional neural network trained for image classification, such as a ResNet-18 model). The machine learning model can be trained to determine a confidence level that a newly geofenced area represents an area of missed work. For example, the machine learning model can be trained to generate a classification indicating a low confidence, a moderate, or a high confidence that the newly geofenced areas represent areas of missed work. The machine learning can be configured to do so for multiple generated geofences in the aggregated for each individual geofences. To generate such confidence levels, the geofence generator 112 can input the overlaid image (e.g., the image without the outline of the new geofences) without a legend axis, or any titles (e.g., without context of the image). The geofence generator 112 can execute the machine learning model to cause the machine learning model to classify the overlaid image to indicate whether the new geofences have a low, moderate, or high likelihood of being overlaid on areas of missed work. The geofence generator 112 can store the classification with the geofences. In some cases, the geofence generator 112 may only store the newly generated geofences responsive to the machine learning model output a classification of moderate or high. Thus, the machine learning model can operate as a catch to avoid generating geofences in areas for which missed work is not likely to occur, which can cause unnecessary processing resources to be used to process GPS data points.

The geofence generator 112 can generate an alert for the different generated geofences generated based on the GPS data points 116. The geofence generator 112 can include identifications of the different geofences, the locations of the geofences, the raw image of the geographic region, or the image overlaid with the new geofences. The geofence generator 112 can transmit the alert as an electronic message notification or via a chat application.

Additionally or instead, the geofence generator 112 can generate or save geojson files for each of the respective new geofences in the data repository 126 as new geofences 118. In doing so, data about the new geofences can be retrieved from a portal or platform provided by the data processing system.

The data processing system 102 can perform the above-described process separately for individual vehicles or for another criteria. For example, the data processing system 102 may only cluster GPS data points and generate cores and geofences from GPS data points of a single vehicle or individual vehicles. In another example, the data processing system 102 may do so for a specific set or vehicles, for a particular customer (e.g., farm owner), and/or for a specific time period. The data processing system 102 can do so based on defined parameters in a request initiating the process or based on a configuration of the data processing system 102. Accordingly, the geofence generation process can be configurable to only use data from sources preferred by a user or that an administrator trusts.

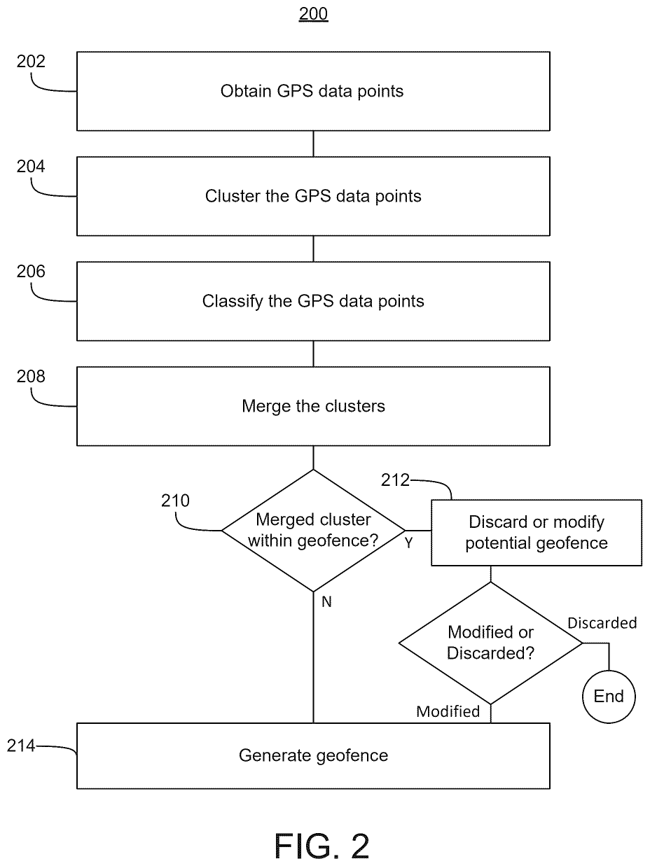

FIG. 2 is an illustration of an example method 200 for generating geofences, in accordance with implementations. The method 200 can be performed by one or more systems or components depicted in FIG. 1, or FIG. 12, including, for example, a data processing system and location sensor device.

At ACT 202, the data processing system can obtain GPS data points. The data processing system can obtain the GPS data points from a location sensor device that is attached to, connected to, or located on one or more agricultural vehicles. The data processing system can receive the GPS data points as the agricultural vehicles travel around a geographical region performing farm work, such as plowing, harvesting, or spraying.

In one example, the data processing system can receive one or more GPS data points. The data processing system can receive the GPS data points from a device or sensor located on the vehicle or communicatively coupled to the vehicle. The data processing system can receive the location points via a network, such as a cellular network. The GPS data points can include GPS location information, such as latitude and longitude coordinates. The GPS data points can each include a timestamp indicating the times in which the GPS data points were generated. Thus, the location data point can indicate a geographic location and timestamp of detection. The location data points can be collected or detected with a resolution. The resolution can be approximately 2 meters. The resolution can be greater than 2 meters or less than 2 meters.

The GPS data points can include one or more subsets of GPS data points that each correspond to a different line segment. For example, each GPS data point can correspond to a task or a trip indicating a farm task the agricultural vehicle was performing when the GPS data point was generated or captured. The GPS data points can additionally or instead correspond to a travel direction of the GPS data points indicating the directions in which the vehicles of the GPS data points were traveling when the GPS data points were generated. The metadata indicating the tasks, trips, or directions (e.g., travel directions) associated with the GPS data points can be stored with the respective GPS data points to indicate the association (e.g., in the same row or column of the respective GPS data points).

At ACT 204, the data processing system can cluster the GPS data points. The data processing system can cluster the GPS data points into multiple clusters using a density-based clustering protocol, such as the density-based spatial clustering of applications with noise (DBSCAN) algorithm. The data processing system can initially cluster the GPS data points without taking any of the metadata regarding the GPS data points into account, in some cases.

At ACT 206, the data processing system can classify the GPS data points. The data processing system can classify each of the GPS data points into one of a group of activity classes comprising drive activity, work activity, and clustered activity. To do so, the data processing system can input each of the GPS data points into a machine learning model (e.g., a support vector machine, a neural network, a random forest, etc.). The data processing system can include other metadata about each GPS data point with the input, such as GPS data points generated immediately before or after the GPS data points (e.g., in a timeseries) were generated. In doing so, the data processing system can include a defined number of data points before or after each GPS data point or GPS data points generated within a defined time period before or after each GPS data point. The data processing system can execute the machine learning model based on the inputs to classify the GPS data points as drive activity, work activity, or clustered activity.

At ACT 208, the data processing system can merge at least a pair of clusters into a merged cluster. The data processing system can merge the two clusters together based on the GPS data points within the two clusters satisfying one or more criteria. For example, the data processing system can identify two clusters that are adjacent to each other (e.g., next to each other without any intervening clusters between them). The data processing system can identify a line segment with a start point at one of the two clusters and an end point at the other of the two clusters. The data processing system can additionally determine both clusters have one or more GPS data points that were classified into the same activity classification (e.g., each cluster has a threshold number of clustered activity GPS data points or each cluster has a threshold number of work activity GPS data points) or that the line segments connecting the two clusters with start point and end point GPS data points between the two clusters are classified with the same activity classification (e.g., the work activity classification). In some cases, the data processing system may only process the pair of clusters responsive to determine each cluster has at least one work activity GPS data point. The data processing system can similarly merge any number of clusters that satisfy such criteria, in some cases merging previously merged clusters with other clusters that satisfy the same criteria.

At ACT 210, the data processing system can determine whether the merged cluster is within or overlaps or intersects with any geofences of the geographical region. The data processing system can determine the merged cluster is not within any geofences by generating a contour (e.g., outline) of the area surrounding the merged cluster. The data processing system can generate the contour by placing the merged cluster onto an image depicting the geographical area at a location within or on the image that corresponds to the geographical location of the merged cluster. The data processing system can retrieve the previously generated geofences of the geographical region. The data processing system can compare the generated contour for the merged cluster with the previously generated geofences to determine if there is any overlap.

In some cases, the data processing system can generate cores (e.g., areas of potential missed work) from the clusters or merged clusters. The data processing system can generate the cores by triangulating the individual clusters (e.g., the merged or unmerged clusters) into triangles. The data processing system determines metrics for the triangles and selects triangles from the individual clusters that satisfy a set of stored criteria. The data processing system can generate a core for each cluster by generating an outline around the perimeter of the selected triangles. The data processing system can determine whether a cluster or merged cluster intersects with an existing geofence by determining if the outline of the cluster intersects with the existing geofence.

Responsive to determining there is overlap between the generated contour of the cluster or the outline of the core and at least one previously generated geofence, at ACT 212, the data processing system can discard or modify the potential geofence associated with the merged cluster. The data processing system can do so based on the configuration of the data processing system. For example, in some cases, the data processing system can automatically discard (e.g., not process any further for generating a geofence) the merged cluster. By doing so, the data processing system can avoid using processing or storage resources for generating a geofence that is repetitive with or that overlaps a previously existing geofence. In another example, in some cases, the data processing system can modify the contouring of the merged cluster. The data processing system can modify the contouring of the cluster or the core to instead be adjacent or even with the overlapping geofence. The data processing system may only modify the contouring at the points of the overlap.

At ACT 214, the data processing system can generate the geofence. The data processing system can generate the geofence for the merged cluster by inputting an image depicting the area around the merged cluster and a center point of the core generated from the merged cluster into an image segmentation machine learning model (e.g., the Segment Anything Model). The data processing system can execute the image segmentation machine learning model to cause the image segmentation machine learning model to segment or contour the area around the center point of the core and outlined by boundaries (which may be defined by objects, such as roads or tree lines) of the area depicted in the image. The segmenting can be the boundaries of the geofence generated for the cluster and core. The data processing system can generate an identifier for the geofence in memory and store location information (e.g., GPS data) of the contouring for the geofence. The data processing system can similarly generate any number of geofences based on merged or unmerged clusters of GPS data points of classified activity for the geographical region.

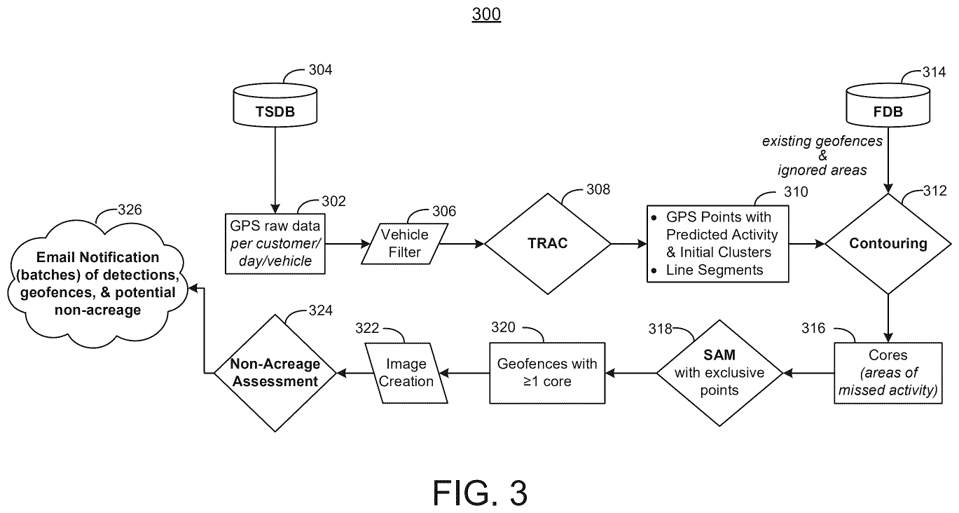

FIG. 3 is an illustration of an example sequence 300 for generating geofences, in accordance with implementations. The sequence 300 can be performed by one or more systems or components depicted in FIG. 1, or FIG. 12, including, for example, a data processing system and location sensor device.

At ACT 302, the data processing system can retrieve GPS data points. The data processing system can retrieve GPS data points from a first data structure or database 304. The GPS data points can be generated from location sensor devices attached to one or more agricultural vehicles (e.g., spraying devices, harvesting equipment, crop foragers, etc.). The GPS data points can correspond to different vehicles or customers. The data processing system can obtain the GPS data points from a location sensor device that is attached to, connected to, or located on one or more agricultural vehicles. The data processing system can receive the GPS data points as the agricultural vehicles travel around a geographical region and perform farm work, such as plowing, harvesting, or spraying and store the GPS data points in the database 304. The data processing system can retrieve GPS data points that are within a geographical region in response to a request to generate one or more geofences in areas of missed work (e.g., areas in which work is performed but for which there is not an assigned geofence) in the geographical region from a client device.

AT ACT 306, the data processing system can filter out GPS data points from vehicles. The data processing system can filter out GPS data points to identify GPS data points of vehicles that likely contain work activity outside of known geofences. For instance, the data processing system can remove any retrieved GPS data points from vehicles for which the data processing system has not received or stored at least a threshold number (e.g., 100) GPS data points.

The data processing system can execute a density-based clustering protocol, such as DBSCAN, on the remaining GPS data points to generate one or more clusters of GPS data points. The data processing system can extract the hull (e.g., identify a boundary including each data point of cluster) of each cluster. The data processing system can compare the hulls to the stored geofences to determine if there are any intersections. The data processing system can identify vehicles that correspond to GPS data points in a cluster with a hull that does not intersect with any known geofences and filter out any GPS data points that originate from the remaining vehicles.

At ACT 308, the data processing system can execute a data point classification machine learning model. The data point classification machine learning model can be configured or trained to classify GPS data points as one of work activity, drive activity, or clustered activity. The data processing system can input the GPS data points originating from the vehicles identified at ACT 306 into the data point classification machine learning model and execute the data point classification machine learning model. The data processing system can additionally or instead include a time series of GPS data points for each GPS data point in the input to give context to the GPS data points. The data point classification machine learning model can classify the GPS data points based on the inputs.

The GPS data points can correspond to line segments. The line segments can include a bearing, a start point, or an end point and can include at least two GPS data points. The data processing system can determine the line segments as part of a trip or task performed by the vehicles for which the GPS data points were generated.

At ACT 310, the data processing system can merge or filter out the clusters using the classifications of the GPS data points of the clusters or the line segments. For example, the data processing system can merge pairs of clusters that include at least a defined number of line segments with a start point data point in one of the clusters and an ending data point in the other of the pair of clusters in which the start point data point and the ending data point are of the same classification (e.g., the work classification). The data processing system can remove or discard from processing any clusters without any GPS data points that are classified as work activity.

At ACT 312, the data processing system can contour the remaining clusters. To do so, the data processing system can triangulate the GPS data points in each of the respective clusters, such as by using Delaunay triangulation. The data processing system can determine metrics for the triangles, such as the original triangle object, a shrunken version of the triangle object, a count of line intersects, the area, the rectangularity, or the maximum distance recorded between an intersecting line and the triangle's furthest vertex. The data processing system can select triangles to use for the contouring based on the metrics. The data processing system can generate a bounding box around the perimeter of the selected triangles of the respective clusters to contour the clusters.

In some cases, the data processing system can generate such clusters or cores for individual vehicles or customers or for GPS data points generated within a particular time period (e.g., in a day). The data processing system can do so based on an input in the request from the client device that requested generation of the new geofences. By doing so, when the data processing system generates key performance indicators (KPIs) or other work data, the data processing system may be able to only perform processing of work data generated for the requested vehicle, customer, or time period, thus still reducing the processing resources than would be required if the data processing system were to process all data generated within the new geofenced area.

At ACT 318, the data processing system can segment the generated cores into geofences. The data processing system can do so, for example, by inputting the locations of the center points of the cores as well as identification of the outlines of the cores into an image segmentation model (e.g., a segment anything model). The data processing system can execute the model based on the input to cause the image segmentation model to segment the outlines of the cores or the areas around the cores. In doing so, the data processing system can retrieve the locations or outlines of the existing geofences from a geofence database 314 and modify the new geofences around the outlines of the existing geofences. The generated segments can outline new generated geofences 320.

At ACT 322, the data processing system can generate a visual representation of the newly generated geofences. The data processing system can do so, for example, by retrieving an image of the geographical region and overlaying the newly generated geofences on locations of the image that correspond with the geographic locations of the geofences.

At ACT 324, the data processing system can input the visual representation of the newly generated geofences into a classification machine learning model that is configured to classify the accuracy of newly generated geofences as depicted on visual representations of the geofences over overhead view images. The classification machine learning model can classify the accuracy of the newly generated geofences into one of the classifications of low, moderate, or high.

At ACT 326, the data processing system can generate an electronic message identifying the newly generated geofences. The data processing system can transmit the electronic message to the client device that requested creation of the geofences for the geographical region or otherwise upload identifications of the newly created geofences to a platform hosted by the data processing system that a user of the client device can access.

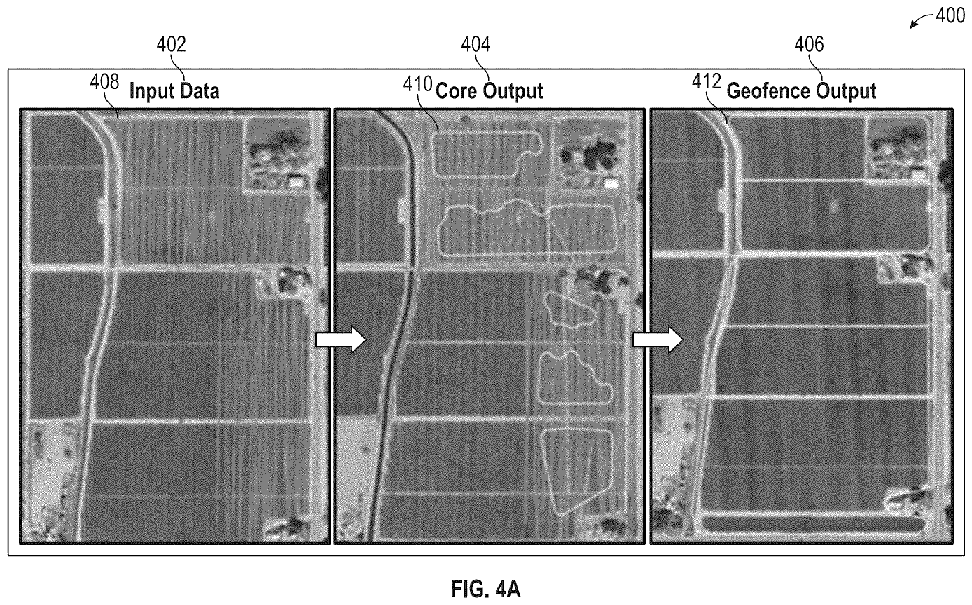

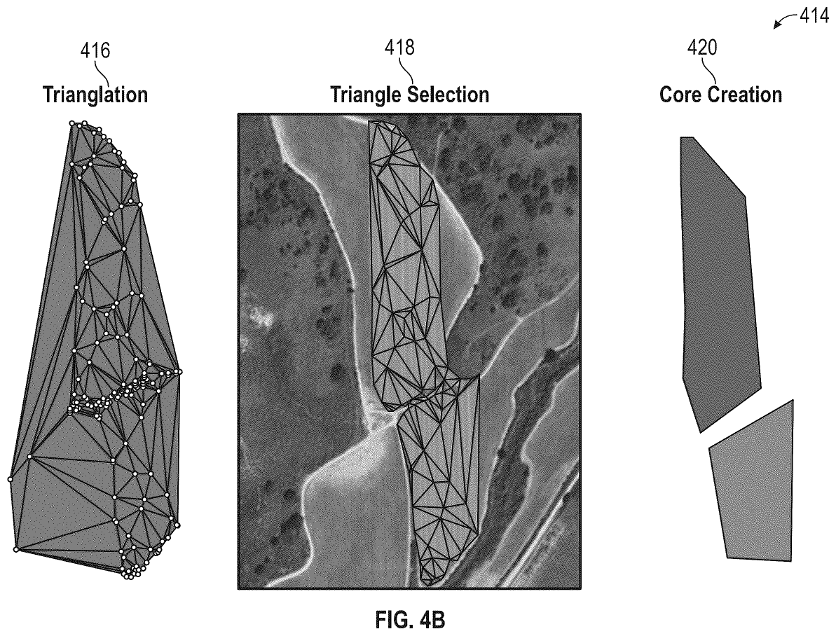

FIG. 4A is an illustration of an example sequence 400 of segmenting an image, in accordance with implementations. The sequence 400 illustrates outputs that can be generated by one or more systems or components depicted in FIG. 1 or FIG. 12, including, for example, a data processing system.

The sequence 400 can include input data 402 that is input into the one or more computing models of a data processing system. The input data 402 can include GPS data points 408 generated by location sensors of the vehicles that have generated at least a threshold number of GPS data points and that have been clustered into clusters outside of previously generated geofences. The data processing system can execute the computing models to generate cores 410 from the GPS data points. The data processing system can input the cores into an image segmentation model with an image of the overhead view of the geographic region. The data processing system can execute the image segmentation model based on the input to generate boundaries of geofences 412 within the geographic region.

FIG. 4B is an illustration of an example sequence 414 of creating cores, in accordance with implementations. The sequence 400 illustrates outputs that can be generated by one or more systems or components depicted in FIG. 1 or FIG. 12, including, for example, a data processing system.

The sequence 414 can include an illustration 416 of clustered GPS data points that have been triangulated by the data processing system. The data processing system can determine metrics of the different triangles from the triangulated data points. The data processing system can use the metrics to select a set of triangles, as illustrated in an illustration 418. The data processing system can generate cores as the perimeter of the selected triangles, as illustrated in an illustration 420.

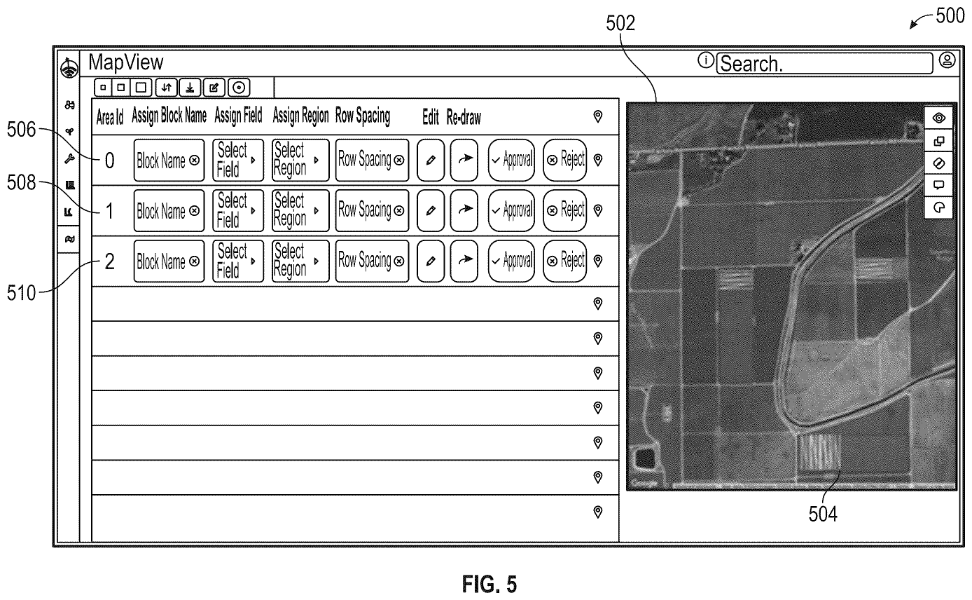

FIG. 5 is an illustration of a graphical user interface 500 for interacting with geofences, in accordance with implementations. The graphical user interface 500 can be generated by one or more systems or components depicted in FIG. 1 or FIG. 12, including, for example, a data processing system.

The data processing system can generate the graphical user interface 500 for display on a platform hosted by the data processing system. The graphical user interface 500 can include an image 502 of an overhead view of a geographical region. The image 502 can include areas 504 for which the data processing system generated geofences. The different geofences are represented on rows 506-510. A user can select an option to approve or reject generation of the different geofences. Responsive to selecting an approval button for a geofence, the data processing system can store the approved geofence. Otherwise, the data processing system can delete or remove the geofence from memory.

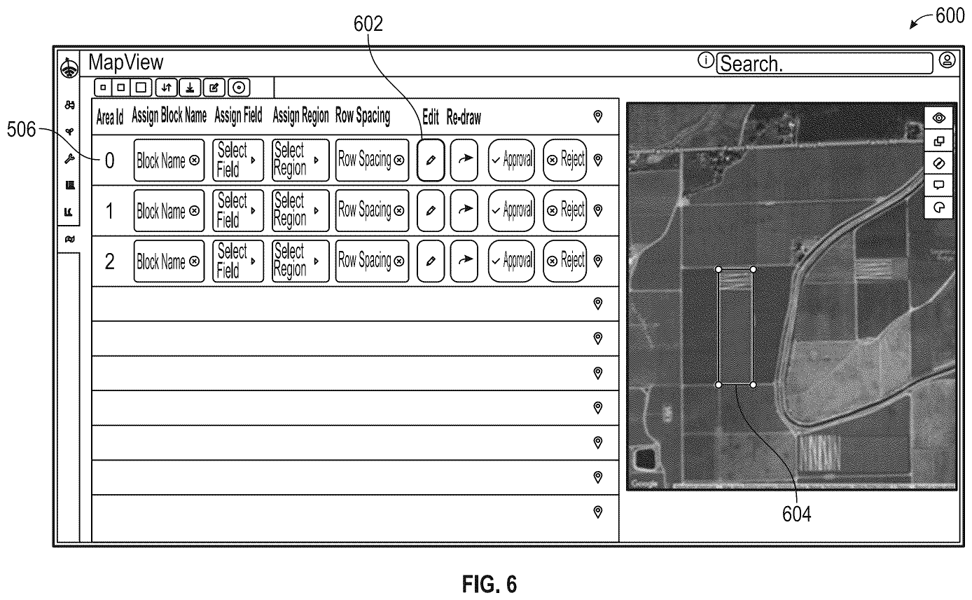

FIG. 6 is an illustration of a graphical user interface 600 for interacting with geofences, in accordance with implementations. The graphical user interface 600 can be generated by one or more systems or components depicted in FIG. 1 or FIG. 12, including, for example, a data processing system.

The data processing system can generate the graphical user interface 600 in response to a selection of a button to edit a geofence. For example, a user can provide an input to an edit button 602 in the row 506. The selection can cause the data processing system to adjust the depiction of the outline of a geofence 604, which can correspond to the row 506. After selection of the button 602, the user can adjust the boundary or outline of the geofence 604.

In an example, the data processing system can receive 2,500 GPS data points collected over an 8-hour period from an agricultural vehicle operating in a field. The data processing system can apply a preliminary filter requiring a minimum threshold of 100 GPS points and determine the 2,500 GPS data points satisfies this threshold. The data processing system can implement a DBSCAN algorithm with the parameters epsilon (F)=30 meters and minPoints=15 to identify dense clusters of GPS points. The data processing system can identify three clusters: Cluster A, which contains 800 points near the northwest corner of the field, Cluster B which contains 600 points in the central region, and Cluster C, which contains 450 points in the southeast portion.

The data processing system can generate a convex hull to define the boundaries for each identified cluster. The data processing system can compare these hulls against known geofences stored in a database. The data processing system can determine that Cluster A overlaps with a previously defined geofence representing a known work area, while Clusters B and C lie outside any known geofences. The data processing system can identify Clusters B and C for further analysis as potential new work areas.

The data processing system can input the GPS points within Clusters B and C into a machine learning model that classifies each point as either “work activity,” drive activity,” or “clustered activity.” The data processing system can determine that 85% of the points in Cluster B are work activity, characterized by systematic back-and-forth movement patterns typical of agricultural operations. The data processing system can also determine that in Cluster C, 75% of the points are work activity, with the remaining points classified as drive activity or clustered activity.

The data processing system can refine the cluster boundaries by merging adjacent clusters. The data processing system can merge at least two clusters that are connected by GPS points classified as work activity and share similar movement patterns. The data processing system can additionally or instead merge the at least two clusters based on a trip or task represented by a line segment within the clusters having a start point in one of the two clusters and an end point in the other of the two clusters.

After identifying the clusters with work activity, the data processing system can perform a contouring process on the remaining GPS points. The data processing system can filter line segments connecting GPS points using a minimum length threshold of 25 meters and alignment within 20 degrees of dominant bearings, using up to three distinct dominant bearings. The data processing system can then apply Delaunay triangulation to the GPS point clusters to generate connected triangles within the respective clusters.

The data processing system can calculate metrics for each triangle in the clusters, including a shrunken version of the triangle, line intersection count, area, rectangularity, and maximum distance between intersecting lines and triangle vertices. The data processing system can select triangles based on the triangles having a rectangularity greater than 0.35, more than two line intersections, and maximum vertex distances within the 25th and 75th quantiles. The data processing system can generate bounding boxes for the line segments of the selected triangles and merge the selected triangles into simplified polygons.

The data processing system can validate the geometry of the resulting polygons and, where necessary, replace invalid or undersized polygons with their corresponding bounding boxes. In doing so, the data processing system can generate core objects representing areas of detected work activity outside known geofences. The data processing system can then retrieve one or more satellite images for each core object and performs boundary tests to ensure proper coverage.

The data processing system can process the cores through an image segmentation model using the core center points as prompts, beginning with the smallest cores. For each generated segmentation mask, the data processing system can convert the segmentation mask to a polygon object with geospatial metadata. The data processing system can evaluate each processed core for association with previously generated geofences, perform necessary clipping operations, and assess the quality of the segmentation mask. Responsive to the data processing system determining a segmentation mask for a core does not satisfy a quality threshold, the data processing system can discard the core, or otherwise remove the core as an option from being used to generate any new geofences.

The data processing system can generate an image with the generated geofence or geofences overlaying the areas of the geographic region for which the geofences are generated. The data processing system can do so by placing the geofences in the locations of the contouring of the geographic region. For instance, the data processing system can generate the image to display the geofence polygon overlaid on satellite imagery with the corresponding GPS data. The data processing system can display the new image on a client device to show the new generated geofence or geofences.

Referring again to FIG. 1, the data processing system 102 can operate (e.g., automatically operate) to determine or generate row bearings of rows (e.g., crop rows) in a field. The data processing system 102 can do so using a multi-pronged approach. For example, the data processing system 102 can identify an image of a geographical region including an agricultural field and a plurality of global positioning system (GPS) data points from a location device of each of one or more agricultural vehicles. Each GPS data point can indicate a location of an agricultural vehicle operating within the geographical region. The data processing system 102 can sample a portion of the image of the geographical region depicting the agricultural field and one or more rows (e.g., crop rows) within the agricultural field. The data processing system 102 can identify a row bearing template based on a similarity between the row bearing template and rows of the sampled portion of the image and identify a row bearing that corresponds to the row bearing template to identify a first candidate row bearing. The data processing system can use the GPS data points corresponding to locations within the portion of the image to determine a second candidate row bearing. The data processing system 102 can use the first and second candidate row bearings to determine a row bearing for the rows depicted in the portion of image. The data processing system can store an association between the row bearing and the portion of the image in memory.

For example, the data processing system 102 can include a bearing generator 114 designed, constructed, and operational to determine or generate row bearings for rows of a field or another type of geographical region. The bearing generator 114 can determine such row bearings automatically (e.g., at set time intervals or randomly) or in response to requests. For example, the data processing system 102 can store the geofences 118 that cover or include different areas of a geographical region. For each geofence, the bearing generator 114 can automatically determine one or more row bearings for rows (e.g., crop rows) that are located within the geofence. The bearing generator 114 can do so using GPS data points corresponding to locations within the geofence or images that depict the area of the geofence. The bearing generator 114 can determine or generate such row bearings once (e.g., upon generation of the geofence) or at set time intervals (e.g., to update the row bearings as the terrain in the area changes).

In another example, the bearing generator 114 can determine row bearings for an area in response to a request. The bearing generator 114 can receive the request from the client device 134, for example, or another computing device. The request can include location information outlining an area for which to generate the row bearing or an identification of a geofence (e.g., a geofence identified in the geofences 118 of the data repository 126). The bearing generator 114 can identify the outlined area or the area of the geofence in response to the request (e.g., in response to receiving the request) and determine or generate one or more row bearings for the area.

The bearing generator 114 can generate or determine a row bearing for an area depicting a portion of an image using a dual-pronged approach, for example. For instance, the bearing generator 114 can receive an identification or selection of a geofence of the geofences 118 that corresponds to a portion of a geographical region. The bearing generator 114 can receive the identification or selection of the geofence after presenting an indication of the geofence on a user interface at the client device 134, in some cases in a list with indications of other geofences, and a user provides an input selecting the geofence. Responsive to receiving the selection of the geofence, the bearing generator 114 can operate to determine a row bearing for the geofence.

The bearing generator 114 can retrieve or identify an image of the geographical region that includes the area of the selected geofence from the images 120 of the data repository 126. The image can be a satellite image depicting an overhead view of different portions of the area of the selected geofence. The image can be pre-processed or denoised as a greyscale image with enhanced contrast of crop rows or the bearing generator 114 can perform such pre-processing. For example, the bearing generator 114 can apply various denoising filters, such as Gaussian or median filters, to remove high-frequency noise while maintaining edge sharpness at the crop row boundaries.

The bearing generator 114 can sample the image to identify sample images. In doing so, the bearing generator 114 can sample pixels from the area or portion of the image depicting the location corresponding to the selected geofence. For example, a selected geofence can be or correspond to an agricultural field depicted in the identified image. The bearing generator 114 can create a pseudo-random distribution (e.g., even distribution) of points within the extents of the agricultural field. The bearing generator 114 can create the distribution using a Poisson disk sampling method, for example, to ensure that the point centers are not immediately next to each other. The bearing generator 114 can identify a defined number of pixels surrounding the sample points (e.g., 64 pixels×64 pixels or 96 pixels by 96 pixels), which generate small squares depicting different areas within the portion of the image depicting the geofenced agricultural field.

For each of the identified image samples, the bearing generator 114 can attempt to match the image samples (e.g., the identified squares for the sampled points) with row bearing templates 124 stored in the data repository 126. The bearing generator 114 can perform comparisons between an image sample and the bearing templates to match the image sample to a bearing template using a machine learning model, such as a convolutional neural network, trained or configured to generate scores indicating the similarity between images. In some cases, the machine learning model can be specifically trained to generate the similarity between image samples or images and row bearing templates, such as by using supervised or unsupervised learning techniques with a training dataset containing pairs of images and ground truth row bearing templates (e.g., using a loss function and backpropagation techniques). The bearing generator 114 can input the image sample (e.g., identifications or values representing the pixels of the image sample) with a row bearing template into the machine learning model. The bearing generator 114 can execute the machine learning model based on the input to cause the machine learning model to generate a similarity (e.g., a similarity score) between the image sample and the row bearing template. The bearing generator 114 can compare the image sample with the different row bearing templates stored in the data repository 126 to generate similarities between the image sample and the row bearing templates. The bearing generator 114 can determine or identify a matching row bearing template for the image sample comparing the similarities and identifying the row bearing template that corresponds to the highest similarity. The bearing generator 114 can similarly identify matching row bearing templates for each of the image samples identified from the image.

In some cases, the bearing generator 114 can generate or determine similarities between image samples and row bearing templates using a template matching function. For example, to determine a similarity between a row bearing template and an image sample, the bearing generator 114 can compare the row bearing template against overlapping regions of the image sample. In doing so, the bearing generator 114 can use various comparison methods, such as squared difference, cross-correlation, and correlation coefficient. The result of this comparison can be stored in an output image, where each pixel value represents the degree of match at that specific location. The bearing generator 114 can aggregate, average, or determine a mean of the similarities determined for each of the pixels of the output image to determine a similarity between the image sample and the row bearing template.

For example, the bearing generator 114 can slide the row bearing template over the image sample as a sliding window. At each position, the bearing generator 114 can compute the similarity between the row bearing template and the corresponding region of the image sample. In some cases, the bearing generator 114 can implement a mask to refine the comparison by specifying which pixels in the template are to be considered. The bearing generator 114 can generate an output image including pixels that correspond to similarities at the location corresponding to the respective pixels. The bearing generator 114 can aggregate, average, or determine a mean of the similarities determined for each of the pixels of the output image to determine a similarity between the image sample and the row bearing template. The bearing generator 114 can similarly determine a similarity between any number of image samples and any number of row bearing templates in this manner. The bearing generator 114 can identify the row bearing template with the highest similarity to an image sample to identify the row bearing for the image sample.

In some cases, the bearing generator 114 can determine a match by first performing a coarse search to identify the most likely range for a match between an image sample and a bearing template and then performing a more in-depth search to identify the bearing template that most closely matches. The two-step process of performing a coarse search and then a refined search to speed up the process of identifying a match substantially by avoiding comparing the image sample to every available row bearing template.

The bearing generator 114 can perform the coarse search in one of a few manners. In one manner, the bearing generator 114 can perform template matching across the full parameter space but only using templates at a defined increment value (e.g., 2.5 degrees for orientation (between 0 and 180), pi/2 for frequency, phase can be fixed at 0 or another defined value (no shift) between parameters (e.g., frequency, phase shift, or orientation). The bearing generator 114 can determine similarities between the image sample and the templates at the defined increment values. The bearing generator 114 can compare the similarities and rank the similarities in ascending or descending order based on the similarities. The bearing generator 114 can identify a defined number of the highest ranked row bearing templates.

In some cases, the bearing generator 114 can dynamically generate the templates at the defined increment value (e.g., instead of only retrieving the templates from memory). For example, the bearing generator 114 can identify a set of parameters of the templates at the respective incremental values. For each set of parameters, the bearing generator 114 can generate a row bearing template with the parameter. The bearing generator 114 can generate the row bearing template using a generative machine learning model or by using a computer function that is configured to dynamically generate row bearing templates based on an input set of parameters, such as by generating an image of a row bearing template coloring the pixels of the image according to the set of parameters. The bearing generator 114 can generate such row bearing templates and determine similarities between the image sample and the generated templates.

The bearing generator 114 can identify a set of row bearing templates for each of the identified highest ranked row bearing templates that have parameters that are similar to the row bearing template. In some cases, the set of row bearing templates can be pre-defined for the row bearing template. In some cases, the bearing generator 114 can identify the set of row bearing templates based on the parameters being similar to the row bearing template. The bearing generator 114 can do so, for example, by identifying row bearing templates that correspond to at least one parameter within a threshold of the identified row bearing template. In another example, the bearing generator 114 can identify or generate a vector with numerical values representing the parameters of the identified bearing template. The bearing generator 114 can compare the vector with similarly identified or generated vectors for the other row bearing templates. The bearing generator 114 can use a distance function to determine distances between the vector for the identified bearing template and the vectors for the other row bearing templates. The smaller the distance, the higher the similarity between two vectors. The bearing generator 114 can identify a defined number of the row bearing templates that correspond with the lowest distance from the vector for the identified row bearing templates. The bearing generator 114 can repeat this process for each row bearing template determined to be the most similar to the image sample.

Another method of a coarse search is to perform a Fast Fourier Transform on the image sample. The bearing generator 114 can perform the Fast Fourier Transform to identify dominant frequency and orientation of the rows (or one or more of any other parameters) depicted in the image sample. The bearing generator 114 can analyze the periodicity of the image sample in the frequency domain to determine the dominant frequency and orientation in the image sample. The bearing generator 114 can identify a row bearing template that matches or that has a smallest distance from the determined frequency and orientation. The bearing generator 114 can identify a subset of row bearing templates that are the most similar to the identified row bearing template. The bearing generator 114 can do so in the manner described above. In some cases, the bearing generator 114 may only identify the parameters (e.g., the dominancy frequency and orientation of the rows) without identifying stored row bearing templates when using the Fast Fourier Transform for the coarse search.

Another method of a coarse search is to perform a Gabor Wavelet Transform, or other wavelet transform. The bearing generator 114 can do so to decompose the image sample into the frequency and spatial domain. The bearing generator 114 can extract the frequency, orientation, and curvature of the image sample (or one or more of any other parameters) from the decomposition of the image sample. The bearing generator 114 can identify a row bearing template that matches or that has a smallest distance from the determined frequency, orientation, and curvature. The bearing generator 114 can identify a subset of row bearing templates that are the most similar to the identified row bearing template. The bearing generator 114 can do so in the manner described above. In some cases, the bearing generator 114 may only identify combinations of parameters that most closely match (e.g., are a smallest distance from) the extracted frequency, orientation, and curvature of the image sample without identifying stored row bearing templates when using the Gabor Wavelet Transform for the coarse search. The bearing generator 114 can similarly use any wavelet transform to perform the coarse search.

The bearing generator 114 can perform the refined search by comparing the image sample to the row bearing templates of each of the one or more sets of row bearing templates identified in the coarse search. For example, the bearing generator 114 can determine a similarity between the image sample and each row bearing template of the one or more sets of row bearing templates. The bearing generator 114 can compare the similarities to rank the different row bearing templates in ascending or descending order based on the similarities. The bearing generator 114 can identify the row bearing template with the highest similarity or that is ranked the highest in the ranking as being the correct row bearing template for the image sample. The bearing generator 114 can repeat this process to identify a row bearing template that matches or is the most similar to each image sample depicting a part of the selected geofence.

In some cases, the bearing generator 114 can perform the refined search by generating or regenerating the row bearing templates to use for the refined search. For example, when the bearing generator 114 identifies a set of row bearing templates during the coarse search, the bearing generator 114 may not store the identified row bearing templates and may instead discard the row bearing templates from memory to conserve memory resources.

Subsequently, when performing the refined search, the bearing generator 114 can re-generate the row bearing templates as described above and compare the re-generated row bearing templates with the image sample to identify the row bearing template with the highest similarity. In another example, when the bearing generator 114 uses the Fast Fourier Transform for the coarse search, the bearing generator 114 can generate a range of values for different parameters from the search. The bearing generator 114 can generate a set of row bearing templates using different combinations of the ranges and compare the image sample with the set of row bearing templates to identify row bearing template with the highest similarity. In another example, when the bearing generator 114 uses the Gabor Wavelet Transform or another wavelet transform for the coarse search, the bearing generator 114 can generate a set of combinations of parameters for the row bearing templates (e.g., combinations of parameters for row bearing templates that are the most similar to a combination of parameters identified using the Gabor Wavelet Transform or another wavelet transfer). The bearing generator 114 can generate a set of row bearing templates using the set of combinations and compare the image sample with the set of row bearing templates to identify the row bearing template with the highest similarity to the image sample.

The bearing generator 114 can validate the determined row bearing templates. The bearing generator 114 can do so, for example, by comparing the row bearings that correspond to each of the determined row bearing templates matching the image samples of the geofenced area of the image. The bearing generator 114 can determine a circular average or circular mean of the row bearings of the image samples. The bearing generator 114 can determine a standard deviation of the row bearing based on the circular average or circular mean. The bearing generator 114 can compare the standard deviation to a threshold. Responsive to determining the standard deviation is below the threshold, the bearing generator 114 can determine the circular average or circular mean is a candidate row bearing (e.g., a first candidate row bearing) for the geofence. Otherwise, the bearing generator 114 can generate a null value (e.g., −1) indicating a candidate row bearing value could not be determined based on the image.

The bearing generator 114 can additionally or instead use GPS data points 116 or tasks 122 from the data repository 126 to generate another candidate row bearing (e.g., a second candidate row bearing) for the selected geofence. For example, the bearing generator 114 can query the tasks 122 data structures for tasks or trips performed completely or partially within the geofence or that include one or more GPS data points 116 within the selected geofence. In performing the query, the bearing generator 114 can identify or retrieve a defined number (e.g., 250) of the most recent tasks that meet the search criteria, that are of a length above a threshold, or that are associated with a target task. The bearing generator 114 can identify target tasks as tasks that correspond to GPS data points 116 with “taskIDs,” or tags, that include at least one of a predefined list of keywords that correspond with tasks usually associated with work along rows. An example list of keywords can be or include “harv,” “cult,” “spray,” “prun,” “mow,” “spread,” “trim,” “weed,” “leaf,” “disc,” “herbicide” and “hedg.” In cases in which no task IDs are assigned, the bearing generator 114 can identify the defined number of the most recent tasks that meet the search criteria and that are of a length above the threshold.

The bearing generator 114 can identify GPS data points of the identified target tasks or that satisfy the bearing generator 114's query. The bearing generator 114 can convert the GPS data points to line segments that correspond with specific tasks or trips. The bearing generator 114 can do so, for example, by identifying GPS data points that contain matching identifiers for the same respective trips or tasks.

The bearing generator 114 can filter the line segments that correspond with specific tasks or trips in which a vehicle was driving into the area of the geofence. The bearing generator 114 can do so, for example, by identifying a direction of travel assigned to the respective GPS data points or the tasks of the GPS data points. The bearing generator 114 can identify the direction of travel and determine whether the direction is towards the middle or a middle area of the geofence. Responsive to determining the direction of travel is not towards the middle or middle area, the bearing generator 114, such as a direction that is along the boundary of the geofence, the bearing generator 114 can discard (e.g., remove as an option from determining the row bearing of the geofence) or stop processing the line segment.

The bearing generator 114 can determine the second candidate row bearings based on the line segments. To do so, the bearing generator 114 can determine a line segment bearing for each generated line segment or each filtered line segment. The bearing generator 114 can determine the line segment row as an angle relative to a direction (e.g., true north). The bearing generator 114 can determine the segment bearing for each line segment determined for the geofence. The bearing generator 114 can determine an average, circular average, median, or another function on the line segment bearings to determine the second row bearing candidate for the geofence.

The bearing generator 114 can use the first or second candidate row bearings to determine the row bearing for the geofence. The bearing generator 114 can do so, for example, based on a relationship between the first and second candidate row bearings. For instance, the bearing generator 114 can determine a circular difference between the first and second candidate row bearings. The bearing generator 114 can compare the circular difference to a threshold. Responsive to determining the circular difference is below the threshold, the bearing generator 114 can perform a function on the first and second candidate row bearings, such as by determining an average, circular average, or median of the two candidate row bearings. The output of the function can be the row bearing for the geofence.

In cases in which the circular difference between the first and second candidate row bearings exceeds the threshold, the bearing generator 114 can identify the second candidate row bearing generated from the GPS data points as the row bearing for the geofence. The bearing generator 114 can do so because the second candidate row bearing is based on real-world travel data that can be more likely to be accurate than a matched row bearing template.

The bearing generator 114 can store the value of the row bearing in a data structure or otherwise as an association with the geofence. For example, the geofence can correspond to a set of attribute-value pairs indicating whether a row bearing has been determined for the geofence, indicating whether such a row bearing is trusted, or indicating whether the determined row bearing is being used to generate metrics for the geofence. Responsive to determining the row bearing for the geofence, the bearing generator 114 can update the attribute-value pair indicating the row bearing has been determined. The bearing generator 114 can additionally or instead update the attribute-value pair indicating the row bearing can be trusted responsive to determining the two determined row bearings for the geofence are within a threshold of each other. The bearing generator 114 can additionally or instead update the attribute-value pair indicating whether the row bearing is being used to generate metrics for the geofence responsive to generating the row bearing for the geofence. In one example, the bearing generator 114 can update the ‘attribute-value pair indicating whether the row bearing is being used to generate metrics by inserting a flag in the attribute-value pair of the attribute. The flag can indicate or activate a function in which key performance indicators (KPIs) data can be generated from fieldwork performed within the geofence using the row bearing determined for the geofence. The values can be viewed or edited by a user accessing the data structure. The user can select a submit button to activate the changes to the attribute-value pairs related to the row bearing for the geofence. The selection can cause the bearing generator 114 to the results locally in .geojson format. The bearing generator 114 can similarly generate row bearings for any number of geofences.

In one example, the bearing generator 114 can sample a second portion of the image of the geographical region that corresponds to a second geofence to generate a second plurality of image samples. The bearing generator 114 can compare the second plurality of image samples with the row bearing templates 124 using the methods described herein to identify a third candidate row bearing for the second portion of the image. The bearing generator 114 can generate a fourth candidate row bearing for the second portion of the image based on second one or more GPS data points of locations of devices within the second portion of the image. The bearing generator 114 can compare a circular difference between the third and fourth candidate row bearings to a threshold and determine the circular difference exceeds the threshold. Responsive to the determination, the bearing generator 114 store an association between the fourth candidate row bearing that was generated based on the second one or more GPS data points and the second geofence in memory.

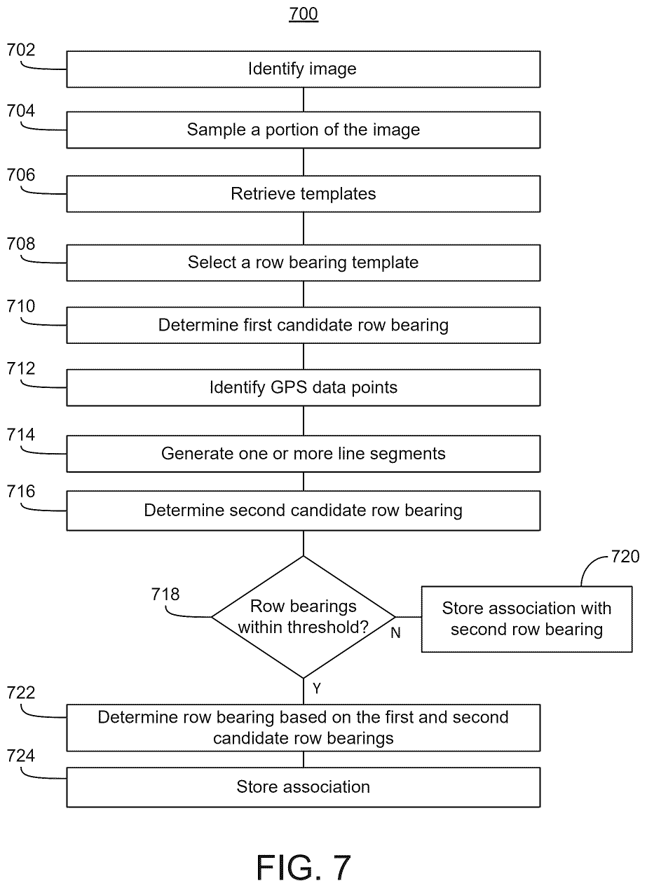

FIG. 7 is an illustration of an example method 700 for identifying row bearings, in accordance with implementations. The method 700 can be performed by one or more systems or components depicted in FIG. 1, or FIG. 12, including, for example, a data processing system and location sensor device.

At ACT 702, the data processing system can identify an image. The image can be of a geographical region. The image can depict an agricultural field within the geographical region. The data processing system can store a geofence with bounds around the agricultural field. The data processing system can store a data structure for the geofence that includes different attribute-value pairs of the geofence. The data processing system can receive a request to generate a row bearing for the geofence or agricultural field.

At ACT 704, the data processing system can sample a portion of the image depicting the agricultural field or the geofence surrounding the agricultural field. The data processing system can sample the portion of the image by identifying groups of pixels that are spaced apart and depict different sections of the agricultural field. The data processing system can sample the portion of the image using a Poisson Sampling technique, for example. In sampling the portion of the image, the data processing system can generate one or more image samples depicting different sections of the agricultural field.

At ACT 706, the data processing system can retrieve one or more row bearing templates. The row bearing templates can each correspond to a different row bearing. The row bearing templates can depict stripes or sinusoids of varying frequencies between the templates. The data processing system can retrieve the row bearing templates from a data repository stored by the data processing system.

At ACT 708, the data processing system can select a row bearing template. The data processing system can select a row bearing template for each image sample. The data processing system can select a row bearing template for each image sample responsive to determining the row bearing template most closely matches, or has a highest similarity, to the image sample, for example.

At ACT 710, the data processing system can determine a first candidate row bearing. The data processing system can determine the first candidate row bearing based on the row bearings that correspond to the selected row bearing templates for the image samples. For example, the data processing system can determine an average, circular average, or median of the row bearings of the selected templates. The average, circular average, or median can be the first candidate row bearing for the agricultural field or geofence.

At ACT 712, the data processing system can identify GPS data points. The data processing system can receive the GPS data points from location sensor devices that are attached to, connected to, or located on one or more agricultural vehicles that operate or operated in the agricultural field. The data processing system can receive the GPS data points as the agricultural vehicles travel around the agricultural field performing farm work, such as plowing, harvesting, or spraying. The GPS data points can include identifiers of trips or tasks the vehicles were performing during operation when the GPS data points were generated.

In one example, the data processing system can receive one or more GPS data points. The data processing system can receive the GPS data points from a device or sensor location on the vehicle or communicatively coupled to the vehicle. The data processing system can receive the location points via a network, such as a cellular network. The GPS data points can include GPS location information, such as latitude and longitude coordinates. The GPS data points can each include a timestamp indicating the times in which the GPS data points were generated. Thus, the location data point can indicate a geographic location and timestamp of detection. The location data points can be collected or detected with a resolution. The resolution can be approximately 2 meters. The resolution can be greater than 2 meters or less than 2 meters.

At ACT 714, the data processing system can generate one or more line segments. The data processing system can generate the line segments from the GPS data points. For example, the data processing system can determine the GPS data points that correspond to the same tasks or trips. The data processing system can do so, for example, based on trip or task IDs included in the metadata of the respective GPS data points. The data processing system can generate line segments between pairs or multiple GPS data points that correspond to a vehicle traveling from a first location to a second location performing a task (e.g., a work-related task).

At ACT 716, the data processing system can determine a second candidate row bearing. The data processing system can determine the second candidate row bearing based on the line segments. For example, the data processing system can determine a line segment bearing for each of the line segments. The data processing system can determine an average, circular average, or median of the determined line segment bearings. The average, circular average, or median can be the second candidate row bearing.

At ACT 718, the data processing system can determine whether a circular difference between the first candidate row bearing and the second candidate row bearing exceeds a threshold. To do so, the data processing system can compare the first candidate row bearing and the second candidate row bearing to determine a circular difference between the two candidate row bearings. The data processing system can compare the circular difference to the threshold to determine whether the circular difference exceeds the threshold.

Responsive to determining the circular difference is greater than the threshold, at ACT 720, the data processing system can store an association between the second candidate row bearing and the geofence in memory. The data processing system can do so, for example, by storing a value of the second candidate row bearing and a flag indicating metrics can be generated for the geofence in the data structure stored for the geofence.

However, responsive to determining the circular difference is less than the threshold, at ACT 722, the data processing system can determine a row bearing for the geofence or agricultural field. The data processing system can determine the row bearing based on or as a function of (e.g., an average, circular average, or median of) the first and second candidate row bearings.

At ACT 724, the data processing system can store an association between the determined row bearing and the geofence in memory. The data processing system can do so, for example, by storing a value of determined row bearing and a flag indicating metrics can be generated for the geofence in the data structure stored for the geofence.

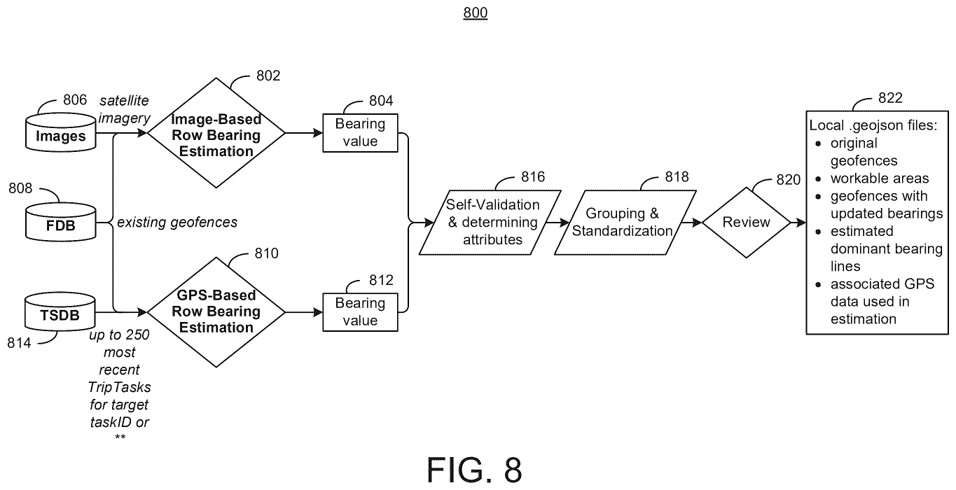

FIG. 8 is an illustration of an example sequence 800 for identifying row bearings, in accordance with implementations. FIG. 8 is an illustration of an example sequence 800 for generating geofences, in accordance with implementations. The sequence 800 can be performed by one or more systems or components depicted in FIG. 1, or FIG. 12, including, for example, a data processing system and location sensor device.

At ACT 802, the data processing system can determine a first candidate row bearing 804 value for a geofence of an agricultural field. To do so, the data processing system can retrieve an image of a geographical region from an image database 806 and data regarding stored geofences for the geographical region from a geofence database 808. The data processing system can present a depiction of the geofences overlaying the image on a user interface being presented on a client device. A user at the client device can select a geofence and select an option requesting to generate a row bearing for the geofence. Responsive to the selection, the data processing system can sample images from the portion of the image depicting the agricultural field. The data processing system can determine a row bearing for each sample based on a matching row bearing template with the sample. The data processing system can determine a circular average, combine, or determine a median of the row bearings of the samples to determine the first candidate row bearing 804.

At ACT 810, the data processing system can determine a second candidate row bearing 812 for the geofence of the agricultural field. The data processing system can do so, for example, by retrieving GPS data points of vehicles operating within the agricultural field from a GPS data point database 814. The data processing system can generate line segments indicating the movement of the respective vehicles in trips or while performing tasks. The data processing system can determine line segment bearings for the respective line segments. The data processing system can determine a circular average, combine, or determine a median of the line segment bearings to determine the second candidate row bearing 812.

At ACT 816, the data processing system can determine a row bearing or validate a determined row bearing. The data processing system can determine the row bearing by determining a circular difference between the first candidate row bearing 804 and the second row bearing 812. The data processing system can compare the circular difference to a threshold. Responsive to determining the circular difference exceeding the threshold, the data processing system can determine the row bearing for the geofence is the second row bearing 812. Responsive to determining the circular difference is below the threshold, the data processing system can determine the row bearing as a function of (e.g., an average, circular average, or median of) the first and second candidate row bearings. The data processing system can determine the row bearing value is validated responsive to the circular difference being less than the threshold or not validated responsive to the circular difference being greater than the threshold.

At ACT 818, the data processing system can group or standardize the row bearing value. The data processing system can standardize the row bearing value based on row bearing values of geofences that are adjacent or within a threshold distance of the geofence for which the data processing system is generating the row bearing value. For example, the data processing system can identify the row bearing values of such geofences and compare the row bearing values with the determined row bearing value of the sequence 800. Responsive to determining a circular difference, the data processing system can adjust (e.g., increase or decrease) the row bearing value of the geofence to match or be closer to the row bearing values of the identified group of geofences (e.g., the circular average row bearing value of the group of geofences). In some cases, the data processing system can adjust the previously generated row bearing value to be closer to the newly generated row bearing value, such as in cases where the newly generated row bearing value matches a row bearing value of a different adjacent geo fence. In doing so, the data processing system can ensure the row bearing values are consistent across geofences for accurate metric determination.

At ACT 820, the data processing system can present the determined row bearing value on a user interface. A user viewing the user interface review the row bearing value and adjust, reject, or accept the row bearing value. The data processing system can receive inputs from the user interface and update the row bearing value accordingly or store the row bearing value in a data structure for the geofence. The data processing system can store the row bearing value in a .geojson file 822 for the geofence.

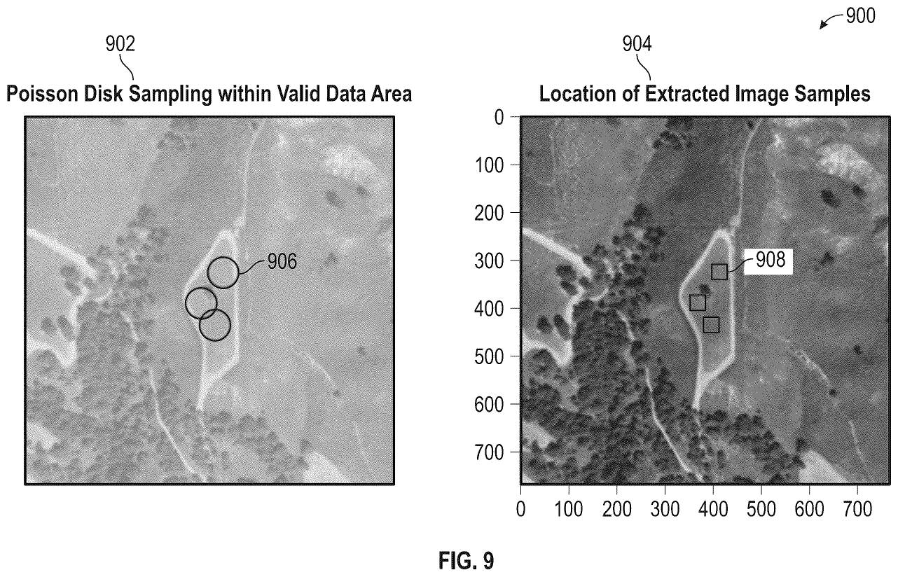

FIG. 9 can include geographical images 900 for image sampling, in accordance with implementations. The images 900 show an example of image sampling that can be performed by one or more systems or components depicted in FIG. 1 or FIG. 12, including, for example, a data processing system.

For example, the images 900 can include an image 902 and an image 904. The image 902 shows an example of sampling sections 906 within a geofence using Poisson Disk Sampling. The image 904 shows image samples 908 that are sectioned off based on the sampling. In this example, the image samples 908 depicted in the image 904 can be 64 pixel by 64 pixels that were extracted for image-based bearing estimation. By using multiple image samples, the data processing system can avoid using image samples with unrelated objects, such as an infield tree.

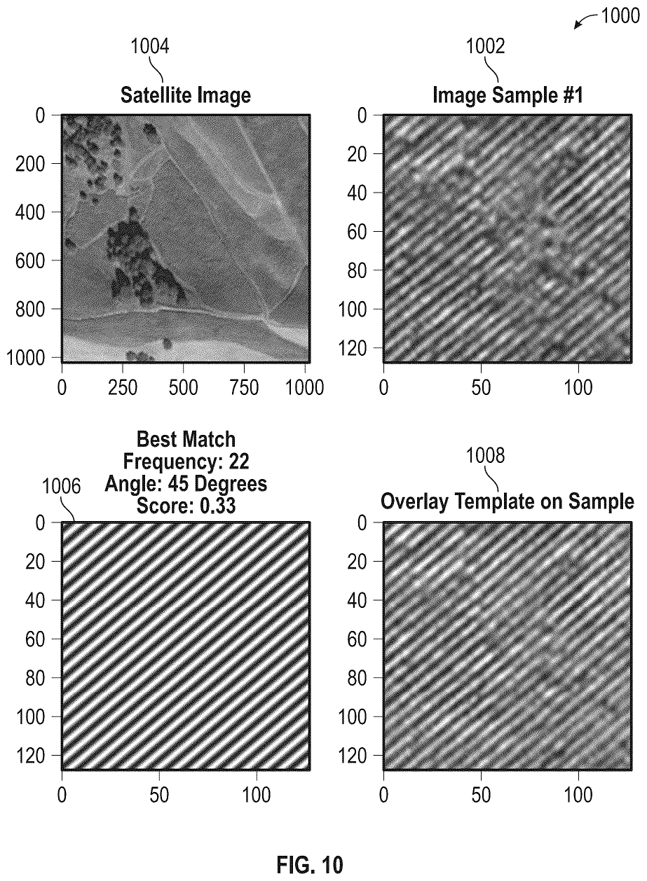

FIG. 10 is an illustration of a sequence 1000 of overlaying a satellite image with a row bearing template, in accordance with implementations. The sequence 1000 can be performed by one or more systems or components depicted in FIG. 1 or FIG. 12, including, for example, a data processing system.

For example, in the sequence 1000, the data processing system can generate an image sample 1002 in a selected geofence of an image 1004. The data processing system can overlay a row bearing template 1006 onto the image sample 1002 to generate an overlaid image sample 1008. The data processing system can input the image sample 1002 and row bearing template 1006 into a machine learning model (e.g., separately or as the overlaid image sample 1008) and execute the machine learning model to generate a similarity score of 0.33 between the row bearing template 1006 and the image sample 1002. Responsive to determining the similarity score is higher than the similarity score of each other row bearing template with the image sample 1002, the data processing system can select the row bearing template 1006 to use to determine a row bearing for the selected geofence. The data processing system can identify the row bearing of the row bearing template 1006 of 45 degrees and use the identified row bearing to determine the row bearing of the selected geofence.

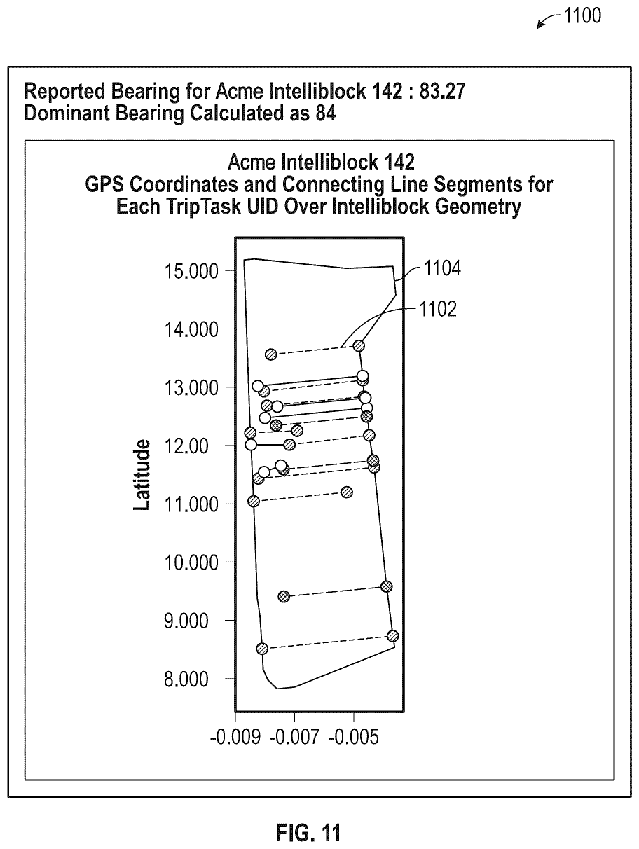

FIG. 11 is an illustration 1100 of row line segments overlaying a map, in accordance with implementations. The illustration 1100 depicts processing performed by one or more systems of components depicted in FIG. 1 or FIG. 12, including, for example, the data processing system, to generate a candidate row bearing GPS coordinates.

As depicted in FIG. 11, the data processing system can generate line segments 1102 from GPS data points collected within a geofence 1104. The data processing system can generate the line segments 1102 based on the GPS data points of the line segments 1102 corresponding to the same trip or task (e.g., the same trip or task ID). The data processing system can determine line segment bearings for each of the line segments 1102 and use the lie segment bearings to determine a candidate row bearing for the geofence 1104.

In an example, a farmer can operate multiple harvesting combines equipped with location devices in a 100-acre cornfield. The data processing system can receive a satellite image of the field along with real-time GPS tracking data (e.g., GPS data points) from the harvesting combines during their harvest operations throughout the day. The data processing system can aggregate the received GPS data points into a data set that can be used for row bearing determination.

The data processing system can sample a 5-acre portion of the satellite image showing distinct corn rows into ten sample images. The data processing system can compare each of the sample images against stored or generated row bearing templates that each correspond with a different row bearing. For each sample image, the data processing system can identify a match between the sample image with a row bearing template showing rows at various row bearings based on the sample image having a similarity with the row bearing template above a threshold or a highest similarity compared with other stored or generated row bearing template. The data processing system can identify the row bearings that correspond with each matching row bearing templates. The data processing system can determine a circular average row bearing of 45 degrees relative to true north of the row bearings corresponding to the matching row bearing templates. The data processing system can identify 45 degrees as a first candidate row bearing for determining the actual row orientation in the 5-acre portion of the field.

The data processing system can additionally or instead analyze the GPS data points collected from the combines working in that 5-acre area. The data processing system can generate line segments from their movement patterns. The data processing system can analyze the line segments and determine the line segments (e.g., on average, circular average, or median) have a row bearing value of 44 degrees relative to true north. The data processing system can identify 44 degrees as a second candidate row bearing for the rows depicted in the portion of the image.

The data processing system can determine or generate a row bearing for the portion of the image based on the first and second candidate row bearings. To do so, the data processing system can determine the circular difference between the two candidate row bearings to be one degree. The data processing system can compare the circular difference to a threshold of two degrees. Responsive to determining the circular difference is below the threshold, the data processing system can calculate a circular average of the two row bearings as 44.5 degrees. The data processing system can determine a row bearing for the portion of the field depicted in the portion of the image is 44.5 degrees and store the value in a database such that the data processing system can use the row bearing value to generate work data or KPIs for the area of the field depicted in the portion of the image.

Generating row bearings for a geofence in the above described manner has several technical advantages. For example, the data processing system described herein can use synthetic two-dimensional sinusoidal gratings as templates (e.g., row bearing templates). The data processing system can identify the best matching template to an image of the area and then use the parameters of the template to determine the row bearing for the area. Testing on this technique has been performed on a dataset of more than 5,000 images taken from a range of customers and has a reported RMSE of 0.26 degrees, which is low and well within an acceptable range, meaning it is extremely reliable. Additionally, the overall method of determining a GPS-based bearing estimation method for individual geofences has been tested on approximately 200 geofences with a reported accuracy of 1.5 degrees, meaning it is also reliable. The dual determination of candidate row bearings to determine a final row bearing for the geofence can overcome any deficiencies that can impact either method, such as poor image quality or inaccurate or spare GPS data availability, thus increasing the overall accuracy of the row bearing determination.

FIG. 12 is a block diagram of an example computer system 1200. The computer system or computing device 1200 can include or be used to implement the system 100 or its components such as the data processing system 102. The computing system 1200 includes a bus 1205 or other communication component for communicating information and a processor 1210 or processing circuit coupled to the bus 1205 for processing information. The computing system 1200 can also include one or more processors 1210 or processing circuits coupled to the bus for processing information. The computing system 1200 also includes main memory 1215, such as a random access memory (RAM) or other dynamic storage device, coupled to the bus 1205 for storing information, and instructions to be executed by the processor 1210. The main memory 1215 can be or include the data repository 126. The main memory 1215 can also be used for storing position information, temporary variables, or other intermediate information during execution of instructions by the processor 1210. The computing system 1200 may further include a read only memory (ROM) 1220 or other static storage device coupled to the bus 1205 for storing static information and instructions for the processor 1210. A storage device 1225, such as a solid state device, magnetic disk or optical disk, can be coupled to the bus 1205 to persistently store information and instructions. The storage device 1225 can include or be part of the data repository 126.

The computing system 1200 may be coupled via the bus 1205 to a display 1235, such as a liquid crystal display, or active matrix display, for displaying information to a user. An input device 1230, such as a keyboard including alphanumeric and other keys, may be coupled to the bus 1205 for communicating information and command selections to the processor 1210. The input device 1230 can include a touch screen display 1235. The input device 1230 can also include a cursor control, such as a mouse, a trackball, or cursor direction keys, for communicating direction information and command selections to the processor 1210 and for controlling cursor movement on the display 1235. The display 1235 can be part of the data processing system 102, the client device 134 or other component of FIG. 1, for example.

The processes, systems and methods described herein can be implemented by the computing system 1200 in response to the processor 1210 executing an arrangement of instructions contained in main memory 1215. Such instructions can be read into main memory 1215 from another computer-readable medium, such as the storage device 1225. Execution of the arrangement of instructions contained in main memory 1215 causes the computing system 1200 to perform the illustrative processes described herein. One or more processors in a multi-processing arrangement may also be employed to execute the instructions contained in main memory 1215. Hard-wired circuitry can be used in place of or in combination with software instructions together with the systems and methods described herein. Systems and methods described herein are not limited to any specific combination of hardware circuitry and software.

Although an example computing system has been described in FIG. 12, the subject matter including the operations described in this specification can be implemented in other types of digital electronic circuitry, or in computer software, firmware, or hardware, including the structures disclosed in this specification and their structural equivalents, or in combinations of one or more of them.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “data processing system” “computing device” “component” or “data processing apparatus” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. For example, the data collector 104, data point clusterer 106, data point classifier 108, contourer 110, geofence generator 112, and bearing generator 114, and other data processing system 102 components can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 102) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or system 1200 can include clients and servers. A client and server are generally remote from each other and typically interact through a communication network (e.g., the network 101). The relationship of client and server arises by virtue of computer programs running on the respective computers and having a client-server relationship to each other. In some implementations, a server transmits data (e.g., data packets representing a digital component) to a client device (e.g., for purposes of displaying data to and receiving user input from a user interacting with the client device). Data generated at the client device (e.g., a result of the user interaction) can be received from the client device at the server (e.g., received by the data processing system 102 from the client device 134 or the remote data source 136).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, the data collector 104, data point clusterer 106, data point classifier 108, contourer 110, geofence generator 112, and bearing generator 114 can be a single component, app, or program, or a logic device having one or more processing circuits, or part of one or more servers of the data processing system 102.

Having now described some illustrative implementations, it is apparent that the foregoing is illustrative and not limiting, having been provided by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A system of geofence creation, comprising:
one or more processors to execute instructions stored in memory to:
obtain a plurality of global positioning system (GPS) data points from a device of each of one or more agricultural vehicles, each GPS data point indicating a location of an agricultural vehicle operating within a geographical region, one or more subsets of the plurality of GPS data points each corresponding to a different line segment having a start point GPS data point and an end point GPS data point;
cluster the plurality of GPS data points into a plurality of clusters according to a density-based clustering protocol;
classify, using a machine learning model, each GPS data point into one of a plurality of activity classes comprising drive activity, work activity, and clustered activity;
merge a pair of clusters of the plurality of clusters into a merged cluster based at least on a first cluster of the pair of clusters comprising a first start point GPS data point of a line segment and a second cluster of the pair of clusters comprising a first end point GPS data point of the line segment and the first cluster and the second cluster each comprising one or more GPS data points of a common activity classification;
determine the merged cluster is not within any geofences of the geographical region; and
responsive to the determination, generate a geofence in an area surrounding the merged cluster within the geographical region.

2. The system of claim 1, comprising the one or more processors to:
retrieve a plurality of geofences each comprising a boundary within the geographical region;
determine the merged cluster is not within the boundary of any of the plurality of geofences; and
generate the geofence in response to determining the merged cluster is not within the boundary of any of the plurality of geofences.

3. The system of claim 1, comprising:
receive a set of GPS data points from a device of a vehicle;
compare a count of the set of GPs data points to a threshold; and
cluster the set of GPS data points responsive to the count of the set of GPS data points exceeding the threshold.

4. The system of claim 1, comprising the one or more processors to:
triangulate a plurality of merged data points within the merged cluster into a plurality of triangles;
generate a core for the merged cluster based on the plurality of triangles;
identify an image of the geographical region; and
generate the geofence based on the core and the image.

5. The system of claim 1, comprising the one or more processors to:
generate a user interface depicting the geofence overlaying an image of the geographical region; and
present the user interface at a client device.

6. The system of claim 1, comprising the one or more processors to:
triangulate a plurality of merged data points within the merged cluster into a plurality of triangles;
select one or more triangles from the plurality of triangles based on metrics generated from the one or more triangles;
generate a core from the selected one or more triangles; and
determine the merged cluster is not within any defined geofences based on a location the core relative to the defined geofences within the geographical region.

7. The system of claim 1, comprising:
determine the geofence is within a threshold distance of a defined geofence; and
responsive to the determination, merge the geofence with the defined geofence.

8. The system of claim 1, comprising the one or more processors to:
identify a cluster of the plurality of clusters;
contour a cluster area surrounding the cluster into a hull;
determine the hull of the cluster does not intersect with any defined geofences; and
classify GPS data points of the cluster responsive to the determination that the hull does not intersect with any defined geofences.

9. The system of claim 1, comprising the one or more processors to:
divide a cluster area containing the first cluster and the second cluster into equal portions; and
merge the pair of clusters based on a distribution of GPS data points of the first and second clusters within the divided cluster area.

10. The system of claim 1, comprising the one or more processors to:
determine at least one of the plurality of clusters does not contain any GPS data points classified as work activity; and
discard each of the at least one clusters based on the determination.

11. A method of geofence creation, comprising:
obtaining, by one or more processors, a plurality of global positioning system (GPS) data points from a device of each of one or more agricultural vehicles, each GPS data point indicating a location of an agricultural vehicle operating within a geographical region, one or more subsets of the plurality of GPS data points each corresponding to a different line segment having a start point GPS data point and an end point GPS data point;
clustering, by the one or more processors, the plurality of GPS data points into a plurality of clusters according to a density-based clustering protocol;
classifying, by the one or more processors using a machine learning model, each GPS data point into one of a plurality of activity classes comprising drive activity, work activity, and clustered activity;
merging, by the one or more processors, a pair of clusters of the plurality of clusters into a merged cluster based at least on a first cluster of the pair of clusters comprising a first start point GPS data point of a line segment and a second cluster of the pair of clusters comprising a first end point GPS data point of the line segment and the first cluster and the second cluster each comprising one or more GPS data points of a common activity classification;
determining, by the one or more processors, the merged cluster is not within any geofences of the geographical region; and
responsive to the determining the merged cluster is not within any geofences of the geographical region, generating, by the one or more processors, a geofence in an area surrounding the merged cluster within the geographical region.

12. The method of claim 11, comprising:
retrieving, by the one or more processors, a plurality of geofences each comprising a boundary within the geographical region;
determining, by the one or more processors, the merged cluster is not within the boundary of any of the plurality of geofences; and
generating, by the one or more processors, the geofence in response to determining the merged cluster is not within the boundary of any of the plurality of geofences.

13. The method of claim 11, comprising:
receiving, by the one or more processors, a set of GPS data points from a device of a vehicle;
comparing, by the one or more processors, a count of the set of GPs data points to a threshold; and
clustering, by the one or more processors, the set of GPS data points responsive to the count of the set of GPS data points exceeding the threshold.

14. The method of claim 11, comprising:
triangulating, by the one or more processors, a plurality of merged data points within the merged cluster into a plurality of triangles;
generating, by the one or more processors, a core for the merged cluster based on the plurality of triangles;
identifying, by the one or more processors, an image of the geographical region; and
generating, by the one or more processors, the geofence based on the core and the image.

15. The method of claim 11, comprising:
generating, by the one or more processors, a user interface depicting the geofence overlaying an image of the geographical region; and
presenting, by the one or more processors, the user interface at a client device.

16. The method of claim 11, comprising:
triangulating, by the one or more processors, a plurality of merged data points within the merged cluster into a plurality of triangles;
selecting, by the one or more processors, one or more triangles from the plurality of triangles based on metrics generated from the one or more triangles;
generating, by the one or more processors, a core from the selected one or more triangles; and
determining, by the one or more processors, the merged cluster is not within any defined geofences based on a location the core relative to the defined geofences within the geographical region.

17. The method of claim 11, comprising:
determining, by the one or more processors, the geofence is within a threshold distance of a defined geofence; and
responsive to the determining, merging, by the one or more processors, the geofence with the defined geofence.

18. The method of claim 11, comprising:
identifying, by the one or more processors, a cluster of the plurality of clusters;
contour a cluster area surrounding the cluster into a hull;
determining, by the one or more processors, the hull of the cluster does not intersect with any defined geofences; and
classifying, by the one or more processors, GPS data points of the cluster responsive to the determination that the hull does not intersect with any defined geofences.

19. The method of claim 11, comprising:
dividing, by the one or more processors, a cluster area containing the first cluster and the second cluster into equal portions; and
merging, by the one or more processors, the pair of clusters based on a distribution of GPS data points of the first and second clusters within the divided cluster area.

20. The method of claim 11, comprising:
determining, by the one or more processors, at least one of the plurality of clusters does not contain any GPS data points classified as work activity; and
discarding, by the one or more processors, each of the at least one clusters based on the determination.

21.-40. (canceled)
